(19) United States
(12) Patent Application Publication
(10) Pub. No.: US 2015/0193199 A1
(43) Pub. Date: Jul. 9, 2015

(54) TRACKING MUSIC IN AUDIO STREAM

(71) Applicant: QUALCOMM Incorporated, San Diego, CA (US)

(72) Inventors: Taesu Kim, Suwon (KR); Minsub Lee, Seoul (KR); Jun-Cheol Cho, Seoul (KR)

(21) Appl. No.: 14/590,662

(22) Filed: Jan. 6, 2015

Related U.S. Application Data
(60) Provisional application No. 61/924,556, filed on Jan. 7, 2014.
(60) Provisional application No. 62/051,700, filed on Sep. 17, 2014.

(51) Int. Cl. G06F 3/16; H04L 29/08

(52) U.S. Cl. CPC G06F 3/165; H04L 67/10

(57) ABSTRACT

A method, performed in an electronic device, for tracking a piece of music in an audio stream is disclosed. The method may receive a first portion of the audio stream and extract a first sound feature based on the first portion of the audio stream. Also, the method may determine whether the first portion of the audio stream is indicative of music based on the first sound feature. In response to determining that the first portion of the audio stream is indicative of music, a piece of music may be identified based on the first portion of the audio stream. Further, upon receiving a second portion of the audio stream, the method may extract a second sound feature based on the second portion of the audio stream and determine whether the second portion of the audio stream is indicative of the first piece of music.

### CROSS-REFERENCE TO RELATED APPLICATION(S)

This application claims the benefit of priority from U.S. Provisional Patent Application Nos. 61/924,556 entitled “METHOD AND APPARATUS FOR IDENTIFYING PIECES OF MUSIC,” filed on Jan. 7, 2014, and 62/051,700 entitled “METHOD AND APPARATUS FOR TRACKING PIECES OF MUSIC,” filed on Sep. 17, 2014, the entire contents of which are incorporated herein by reference.

### FIELD OF THE DISCLOSURE

The present disclosure relates generally to detecting music in an audio stream, and more specifically, to tracking a piece of music in an audio stream in an electronic device.

### DESCRIPTION OF RELATED ART

In recent years, the use of electronic devices such as smartphones, tablet computers, personal computers, and the like has become widespread. Such electronic devices may include sound processing capabilities for capturing and processing music from an input sound. For example, conventional electronic devices may be configured to capture sounds that are output by various sound sources such as a television, a radio, a personal computer, a sound system, a speaker, etc.

Such electronic devices may be equipped with an application that is configured to recognize a song in the captured sounds. In this case, the application may communicate with an external server via a communication network to receive a title and an artist associated with the song. In such electronic devices, a user may choose to run the application manually whenever an unrecognized song is heard. However, manually running the application each time an interesting song is heard may not be very convenient to the user. Accordingly, the application may be set to operate continuously in a background mode by the user to receive and recognize songs so that the user is freed from the task of manually operating the application.

Continuously operating the application, however, typically requires a substantial amount of sound processing and network communications that may lead to considerable power consumption, particularly in mobile electronic devices with a limited power supply. For example, the application may continuously process sounds and communicate with the external server even if no sound or song is received by the mobile devices. Furthermore, even after a song has been recognized from input sounds, the application may continue to receive and process subsequent sounds of the song, which has already been recognized, and communicate with the server to recognize the same song in the subsequent sounds, thereby leading to undesirable power consumption.

### SUMMARY OF THE INVENTION

The present disclosure provides methods and devices for identifying and tracking a piece of music in an audio stream.

According to one aspect of the present disclosure, a method, performed in an electronic device, for tracking a piece of music in an audio stream is disclosed. The method may receive a first portion of the audio stream and extract a first sound feature based on the first portion of the audio stream. Also, the method may determine whether the first portion of the audio stream is indicative of music based on the first sound feature. In response to determining that the first portion of the audio stream is indicative of music, a piece of music may be identified based on the first portion of the audio stream. Further, upon receiving a second portion of the audio stream, the method may extract a second sound feature based on the second portion of the audio stream and determine whether the second portion of the audio stream is indicative of the first piece of music. This disclosure also describes an apparatus, a device, a system, a combination of means, and a computer-readable medium relating to this method.

According to still another aspect of the present disclosure, an electronic device for tracking a piece of music in an audio stream is disclosed. The electronic device may include a music detection unit configured to receive a first portion of the audio stream, extract a first sound feature based on the first portion of the audio stream, and determine whether the first portion of the audio stream is indicative of music based on the first sound feature; a music identification unit configured to identify a first piece of music based on the first portion of the audio stream, in response to determining that the first portion is indicative of music; and a music tracking unit configured to receive a second portion of the audio stream; extract a second sound feature based on the second portion of the audio stream; and determine whether the second portion of the audio stream is indicative of the first piece of music.

### BRIEF DESCRIPTION OF THE DRAWINGS

Embodiments of this disclosure will be understood with reference to the following detailed description, when read in conjunction with the accompanying drawings.

FIG. 1 illustrates an electronic device configured to display information on a piece of music when the piece of music is identified in an audio stream, according to one embodiment of the present disclosure.

FIG. 2 illustrates a plurality of electronic devices configured to communicate with a server via a communication network to obtain identification information associated with a plurality of pieces of music, according to one embodiment of the present disclosure.

FIG. 3 illustrates a block diagram of an electronic device configured to identify a piece of music in an audio stream for updating a music history database in a storage unit, according to one embodiment of the present disclosure.

FIG. 4 illustrates a more detailed block diagram of a sound processing unit in the electronic device that is configured to generate or obtain a music model for a piece of music and track the piece of music based on the music model, according to one embodiment of the present disclosure.

FIG. 5 illustrates a timing diagram for tracking a piece of music in an input sound stream, by the sound processing unit, to determine whether the piece of music has ended, according to one embodiment of the present disclosure.

FIG. 6 illustrates a timing diagram for sampling a portion of a piece of music in an audio stream and determining whether a subsequent portion in the audio stream is a portion of the piece of music, according to one embodiment of the present disclosure.

FIG. 7 is a flowchart of a method, performed in an electronic device, for identifying and tracking a piece of music in an audio stream, according to one embodiment of the present disclosure.

FIG. 8 illustrates a detailed method for identifying a piece of music based on at least one sound feature extracted from a portion of an audio stream, according to one embodiment of the present disclosure.

FIG. 9 illustrates a detailed method for tracking a piece of music based on a music model associated with the piece of music, according to one embodiment of the present disclosure.

FIG. 10 illustrates a more detailed block diagram of a music management unit in an electronic device configured to receive identification information for a piece of music, manage a music history database, and generate recommendations and notifications, according to one embodiment of the present disclosure.

FIG. 11 illustrates a block diagram of a mobile device in a wireless communication system in which the methods and apparatus of the present disclosure for identifying a piece of music from an audio stream and tracking the piece of music may be implemented according to some embodiments.

FIG. 12 is a block diagram illustrating a server system, which may be any one of the servers previously described, for searching and providing information on a piece of music implemented according to some embodiments.

### DETAILED DESCRIPTION

Reference will now be made in detail to various embodiments, examples of which are illustrated in the accompanying drawings. In the following detailed description, numerous specific details are set forth in order to provide a thorough understanding of the present subject matter. However, it will be apparent to one of ordinary skill in the art that the present subject matter may be practiced without these specific details. In other instances, well-known methods, procedures, systems, and components have not been described in detail so as not to unnecessarily obscure aspects of the various embodiments.

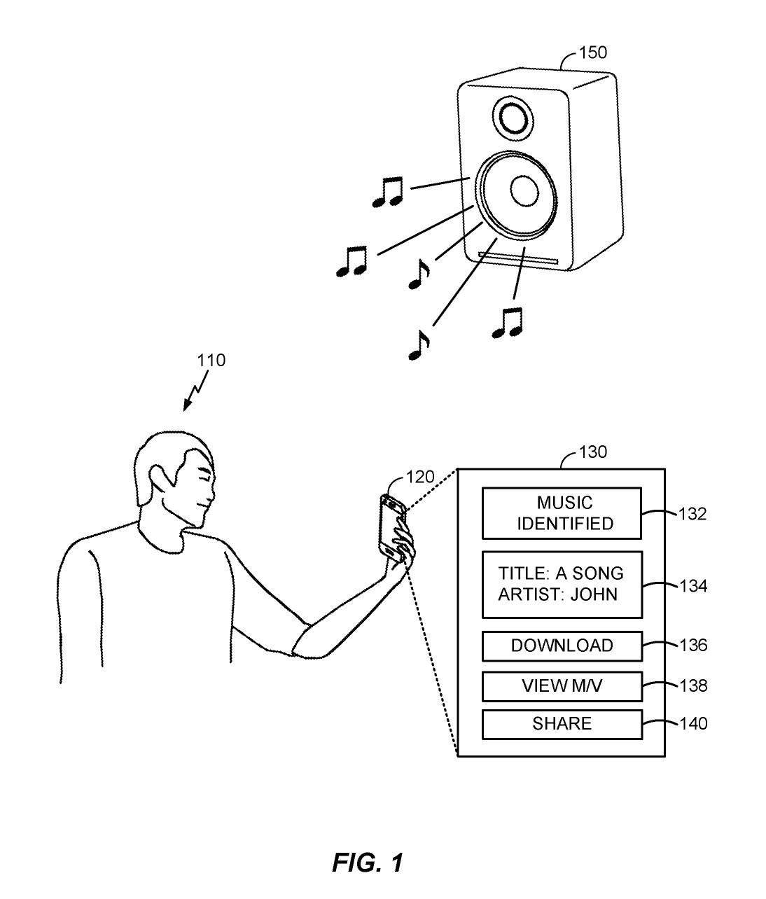

FIG. 1 illustrates an electronic device 120 configured to display information associated with a piece of music when the piece of music is identified in an audio stream, according to one embodiment of the present disclosure. As used herein, the term “music” may refer to any type of sound that may be characterized by one or more elements of rhythm (e.g., tempo, meter, and articulation), pitch (e.g., melody and harmony), dynamics (e.g., volume of a sound or note), or the like, and may include sounds of musical instruments, voices, etc. In addition, the term “a piece of music” herein may refer to a unique or distinct musical work or composition and may include creation or reproduction of such musical work or composition in sound or audio form such as a song, a tune, and the like. Further, the term “audio stream” may refer to a sequence of one or more electrical signals or data representing one or more portions of a sound stream, which may include a plurality of pieces of music, environmental sounds, speech, noise, etc.

The electronic device 120 may be any electronic device equipped with sound capturing and processing capabilities and communication capabilities, such as a cellular phone, a smartphone, a wearable computer, a smart watch, smart glasses, a personal computer, a laptop computer, a tablet computer, a smart television, a gaming device, a multimedia player, etc. In the illustrated embodiment, the electronic device 120 is shown as a smartphone, which may receive an input sound stream from a speaker 150, including sounds corresponding to a piece of music, and convert the input sound stream into an audio stream. As the input sound stream is being received and converted into the audio stream, the electronic device 120 may detect sound and music, and identify a piece of music in the audio stream. In one embodiment, sound may be detected in the audio stream based on a predetermined threshold sound intensity. Upon detecting sound, the electronic device 120 may start detecting music in the audio stream.

Once music is detected in the audio stream, the electronic device 120 may obtain identification information for a piece of music, which is associated with the detected music. The identification information for the piece of music may be received from an external device (not shown) or retrieved from an internal database (not shown) of the electronic device 120. Upon obtaining the identification information, the electronic device 120 may display the identification information on a display screen 130. As used herein, the term “identification information” may refer to any information that may identify or describe a piece of music, and may include at least one among a title, an artist, a duration, a link to a music video, a rating, a music jacket cover, a review, a download status, and the like. In one embodiment, a user 110 of the electronic device 120 may view the identification information for the piece of music that is currently being played by the speaker 150.

In the illustrated embodiment, the electronic device 120 may display a notification 132 that the piece of music has been identified, and identification information 134 including a title and a name of an artist for the identified piece of music on the display screen 130. Additionally, the electronic device 120 may display a download icon 136, a view M/V (music video) icon 138, and a share icon 140 for the piece of music. The user 110 may select (e.g., touch on) the icons 136, 138, and 140 to download the piece of music, view a music video of the piece of music, and share the piece of music with others, respectively. For example, when the icon 136 is selected, an audio file or data for the identified piece of music may be downloaded to the electronic device 120. In some other examples, the user 110 may view a music video associated with the piece of music, which may be streamed from the external server, by selecting the icon 138, or may share the piece of music with friends through an e-mail, a social networking application, a cloud storage server, etc., by selecting the icon 140.

While the illustrated embodiment shows displaying the notification 132 that the piece of music has been identified on the display screen 130, the present disclosure is not limited thereto. In some embodiments, the electronic device 120 may store the identification information 134 associated with the identified piece of music in a music history database, which may be provided in a storage unit (not shown) of the electronic device 120, to keep a record of the piece of music. Additionally, the electronic device 120 may include a music history management application to display a list of pieces of music stored in the music history database and a recommendation based on the music history database. In this case, the user 110 may activate the music history management application to view the list of pieces of music and the recommendation.

In addition to obtaining the identification information 134 for the piece of music as described above, the electronic device 120 may track the piece of music in the audio stream to detect an end of the piece of music. In other words, as the audio stream is generated from the input sound stream, the audio stream may be monitored to determine whether the same piece of music is still being played or not. For example, the end of the piece of music may be detected when the reproduction of the entire piece of music is completed or when the piece of music changes to another piece of music without the entire piece of music being reproduced.

According to some embodiments, a music model for the piece of music may be generated or obtained for use in detecting the end of the piece of music. As used herein, the term “music model” may be interchangeably used with a “sound model” and may refer to a model representing sound characteristics of a piece of music, including, but not limited to, a statistical model of such sound characteristics. In one embodiment, at least one sound feature may be extracted from a portion of the audio stream and the music model for the piece of music may then be generated in the electronic device 120 based on the at least one sound feature. For example, the sound feature may be an audio fingerprint, an MFCC (Mel-frequency Cepstral coefficients) vector, or the like, and the music model may be a GMM (Gaussian mixture model) or the like. In another embodiment, the electronic device 120 may transmit the at least one sound feature to an external device (not shown), which may include a plurality of music models, and receive a music model determined to be associated with the at least one sound feature, among the plurality of music models, from the external device. The electronic device 120 may also retrieve the music model for the piece of music from a music model database (not shown) stored in the electronic device 120. Additionally or alternatively, the extracted at least one sound feature (e.g., an audio fingerprint, an MFCC vector, or the like) itself may be used as the music model in some embodiments of the present disclosure.

To detect the end of the piece of music, the electronic device 120 may sample at least one portion of the audio stream and determine whether or not the sampled portion is indicative of the piece of music based on the music model. By determining whether or not the sampled portion is indicative of the piece of music, it may be determined whether or not the sampled portion is a portion of the piece of music, and also whether or not the piece of music has ended. The sampled portion of the audio stream may follow the portion of the audio stream from which the at least one sound feature has been extracted for generating or obtaining the music model. In this process, the electronic device 120 may sample a plurality of portions of the audio stream continuously, periodically, or aperiodically, and determine whether at least one of sampled portions is not a portion of the piece of music, or whether at least one of sampled portions is a portion of the piece of music. As used herein, the phrase “determining whether a portion of an audio stream is a portion of a piece of music” may refer to determining whether the portion of the audio stream is indicative of the piece of music, and may encompass either positive test (i.e., determining whether a portion of an audio stream is indicative of a piece of music) or negative test (i.e., determining whether a portion of an audio stream is not indicative of a piece of music). Also, the phrase “determining whether a portion of an audio stream is not a portion of a piece of music” may refer to determining whether the portion of the audio stream is indicative of a different sound such as another piece of music, speech, noise, silence, etc.

In some embodiments, the speaker 150 may continuously, periodically, aperiodically or intermittently output a sequence of a plurality of pieces of music. In this case, the electronic device 120 may continuously receive an input sound stream including the sequence of the plurality of pieces of music and convert the input sound stream into an audio stream. When an end of one of the pieces of music is detected by monitoring the audio stream in the manner as described above, the electronic device 120 may proceed to detect sound and music for another piece of music. In addition, the electronic device 120 may sequentially obtain identification information to identify the plurality of pieces of music in the audio stream. The identification information for the plurality of pieces of music may be stored in the music history database to keep a record of the identified pieces of music.

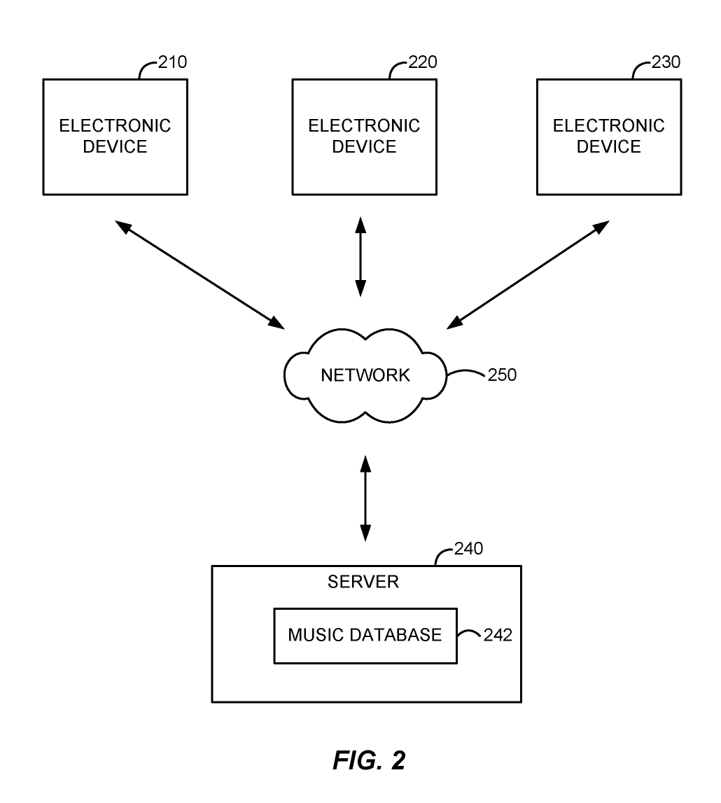

FIG. 2 illustrates a plurality of electronic devices 210, 220, and 230 configured to communicate with a server 240 via a communication network 250 to obtain identification information associated with a plurality of pieces of music, according to one embodiment of the present disclosure. The communication network 250 may include one or more wired and/or wireless communication networks, such as the Internet, other wide area networks, local area networks, metropolitan area networks, and so on. Further, the electronic devices 210, 220, and 230 may communicate with the server 240 via the communication network 250 by using various communication technologies such as Code Division Multiple Access (CDMA), Global System for Mobile Communications (GSM), Wideband CDMA (W-CDMA), Long Term Evolution (LTE), LTE-Advanced, LTE Direct, Wi-Fi, Wi-Fi Direct, Near-Field Communication (NFC), Bluetooth, Ethernet, and the like.

The server 240 may store a music database 242 that may include identification information for a plurality of pieces of music. The identification information may include at least one among a title, an artist, a duration, a link to a music video, a rating, a music jacket cover, a review, a download status, and the like. In some embodiments, the music database 242 may include a plurality of identification information items, each of which may be associated with one of the plurality of pieces of music.

Further, the music database 242 may also include a plurality of music models, each of which may be indicative of one of the plurality of pieces of music. The music models may be statistical models of sound characteristics, or may include the sound characteristics or sound features (e.g., audio fingerprints, MFCC vectors, etc.). Although the three electronic devices 210 to 230 are illustrated in FIG. 2, any other suitable number of electronic devices, including the electronic device 120 in FIG. 1, may communicate with the server 240 via the communication network 250.

In the illustrated embodiment, the electronic devices 210 to 230 may be located at different locations and continuously, periodically, or aperiodically receive different input sound streams that include sounds corresponding to different pieces of music. Each of the electronic devices 210 to 230 may convert a received input sound stream into an audio stream. As the input sound stream is received and converted into the audio stream, each of the electronic devices 210 to 230 may detect sound in the audio stream and start detecting music in the audio streams.

Once music is detected in the audio streams, the electronic devices 210 to 230 may start processing the audio streams to identify pieces of music in the respective audio streams. For example, when music is detected, the electronic device 210 may start extracting at least one sound feature from the audio stream. In some embodiments, the at least one sound feature may be extracted using any suitable feature extraction scheme such as an audio fingerprint method, an MFCC method, etc. In this case, the electronic device 210 may initially extract at least one sound feature that can be used to identify a piece of music in the audio stream. The at least one sound feature extracted in the electronic device 210 may then be transmitted to the server 240 via the communication network 250. Although the illustrated embodiment of FIG. 2 is described with reference to the electronic device 210, the electronic devices 220 and 230 may also be configured to perform and operate in a similar manner as the electronic device 210.

Upon receiving the at least one sound feature from the electronic device 210, the server 240 may access the music database 242 to obtain identification information associated with the at least one sound feature. In one embodiment, the server 240 may compare the received at least one sound feature with the music models in the music database 242 and identify a music model that corresponds to the least one sound feature. The server 240 may then identify a piece of music associated with the identified music model and retrieve identification information for the identified piece of music from the music database 242. The retrieved identification information for the piece of music may be transmitted to the electronic device 210.

Upon receiving the identification information associated with the piece of music, the electronic device 210 may obtain a location of the electronic device 210 and a time at which the piece of music is received and update a music history database with the identification information, the location, and the time for the piece of music. Once the identification information for the piece of music is received from the server 240, the electronic device 210 may not communicate with the server 240 any longer until music for a different piece of music is detected in the audio stream.

In some embodiments, the server 240 may also transmit the music model associated with the identified piece of music to the electronic device 210. Upon receiving the music model, the electronic device 210 may start tracking the piece of music in the audio stream to detect an end of the piece of music. As the audio stream is generated from the input sound stream, the electronic device 210 may monitor the audio stream to detect an end of the piece of music in the audio stream. According to one embodiment, the electronic device 120 may sample a portion of the audio stream and determine whether the sampled portion is indicative of the piece of music (i.e., whether the sampled portion is a portion of the piece of music) based on the music model.

By receiving and storing identification information for a plurality of pieces of music to update the music history database, the electronic device 210 may provide a variety of information relating to the pieces of music. In one embodiment, the electronic device 210 may generate a list of frequently-heard pieces of music based on the music history database and provide a recommendation to a user for downloading or purchasing one or more pieces of music. Additionally or alternatively, the electronic device 210 may select a piece of music in the list of frequently-heard pieces of music such that the selected piece of music is streamed from an external server (e.g., the server 240 or another server). Further, the electronic device 210 may provide a list of pieces of music that are heard in one or more time periods or locations together with the times or locations associated with the pieces of music.

In another embodiment, the identification information for a piece of music from the server 240 may include additional information indicating that the piece of music is available for free download or associated with a particular type of music video such as a funny music video, a highly rated music video, etc. Upon receiving the identification information for the piece of music, the electronic device 210 may output the additional information on a screen of the electronic device 210. The additional information may be displayed with one or more icons that may be used to download an audio file of the piece of music or view the associated music video via the communication network 250.

The electronic devices 210 to 230 may be configured to communicate with each other through the communication network 250 or a peer-to-peer communication scheme. For example, the electronic devices 210 and 220 may communicate with each other to share respective music history databases or a subset of such databases. From the music history database of the electronic device 220, the electronic device 210 may determine information relating to pieces of music heard by the user of the electronic device 220, for example, a list of frequently-heard pieces of music and a list of favorite music of the electronic device 220. In another embodiment, the electronic device 210 may upload the music history database or a subset of the database onto a social network service (SNS) server (not shown) through the communication network 250 to share the database with other electronic devices such as the electronic devices 220 and 230.

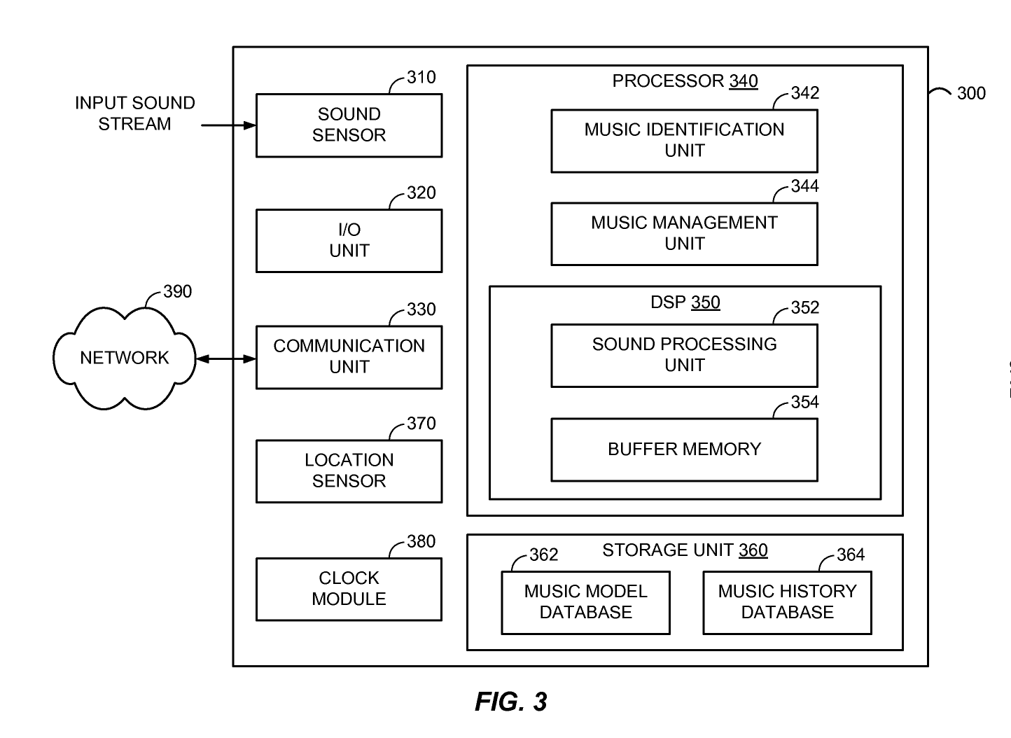

FIG. 3 illustrates a block diagram of an electronic device 300 configured to identify a piece of music in an audio stream for updating a music history database in a storage unit, according to one embodiment of the present disclosure. The electronic device 300 may include a sound sensor 310, an I/O (input/output) unit 320, a communication unit 330, a processor 340, a storage unit 360, a location sensor 370, and a clock module 380. The electronic device 300 may be any suitable device equipped with sound capturing and processing capabilities and communication capabilities, such as a cellular phone, a smartphone, a wearable computer, a smart watch, smart glasses, a laptop computer, a tablet personal computer, a gaming device, a multimedia player, etc. Further, the electronic devices 120, 210, 220, and 230 as described above with reference to FIGS. 1 and 2 may also be configured with the components of the electronic device 300 as illustrated in FIG. 3.

The processor 340 may be any type of processing unit including, but not limited to, an AP (application processor), a CPU (central processing unit), or an MPU (microprocessor unit) employing one or more processing cores, configured to manage and operate the electronic device 300. The processor 340 may include a DSP (digital signal processor) 350 configured to process an audio stream, a music identification unit 342 configured to identify a piece of music from the audio stream, and a music management unit 344 configured to manage a record of the piece of music. In this configuration, the DSP 350 may include a sound processing unit 352 and a buffer memory 354. In one embodiment, the DSP 350 may be a low power processor for reducing power consumption in processing the audio stream. Although the DSP 350 is illustrated to be included in the processor 340, in some embodiments, the DSP 350 may be arranged separately from the processor 340 in the electronic device 300. Additionally or alternatively, the music identification unit 342 and the music management unit 344 may software units provided within the DSP 350.

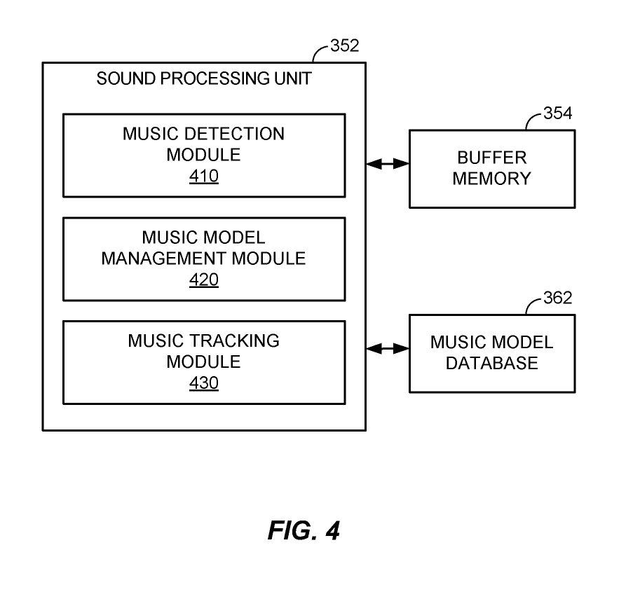

The storage unit 360 may include a music model database 362 and a music history database 364 that can be accessed by the processor 340. The music model database 362 may include one or more music models for use in monitoring the audio stream and to track a piece of music in the audio stream. For example, the music model database 362 may include a predetermined base music model which is used in generating a music model for the piece of music, as will be described below in more detail with reference to FIG. 4. As used herein, the term “base music model” may refer to a music model indicative of generic and/or common sound characteristics, such as pitch, rhythm, dynamics, etc., that may be indicative of music in general. Further, the base music model may be modified into a music model for a specified piece of music based on at least one sound feature which is extracted from the specified piece of music.

The music history database 364 in the storage unit 360 may include a record of one or more pieces of music that have been identified by the electronic device 300 or by a server. For example, the record of the identified pieces of music may include identification information associated with the pieces of music, information on locations and times at which the pieces of music are received, and the like. The information on the locations and the times may be obtained by the location sensor 370 and the clock module 380, as will be described below in more detail. Further, the music history database 364 may include a list of user's favorite music, a list of another user's favorite music, and the like. The storage unit 260 may be remote or local storage, and may be implemented using any suitable storage or memory devices such as a RAM (random access memory), a ROM (read-only memory), an EEPROM (electrically erasable programmable read-only memory), a flash memory, or an SSD (solid state drive).

The sound sensor 310 may be configured to continuously receive an input sound stream which may include a sequence of a plurality of pieces of music and convert the input sound stream into an audio stream. The sound sensor 310 may provide the audio stream to the sound processing unit 352 in the DSP 350. The sound sensor 310 may include one or more microphones or any other types of sound sensors that can be used to receive, capture, sense, convert, and/or detect the input sound stream. In addition, the sound sensor 310 may employ any suitable software and/or hardware for performing such functions.

In order to reduce power consumption, the sound sensor 310 may be configured to receive the input sound stream periodically according to a duty cycle and convert it to the audio stream. For example, the sound sensor 310 may operate on a 10% duty cycle such that the input sound stream is received 10% of the time (e.g., 20 ms in a 200 ms period) and the received portion of the input sound stream may be converted into a portion of the audio stream. In this case, the sound sensor 310 may detect sound from the portion of the audio stream. For example, a sound intensity for the portion of the audio stream may be determined and compared with a predetermined threshold sound intensity. If the sound intensity of the portion of the audio stream exceeds the threshold sound intensity, the sound sensor 310 may deactivate the duty cycle function to continue receiving a remaining portion of the input sound stream and convert it to a remaining portion of the audio stream. In addition, the sound sensor 310 may activate the DSP 350 and provide the DSP 350 with the remaining portion of the audio stream.

When the DSP 350 is activated by the sound sensor 310, the sound processing unit 352 may be configured to receive the portion of the audio stream from the sound sensor 310 and determine whether the received portion of the audio stream includes music (or whether the received portion of the audio stream is indicative of music). In one embodiment, the sound processing unit 352 may extract at least one sound feature from the received portion of the audio stream and determine whether the at least one extracted sound feature is indicative of a sound of interest such as music. The sound feature may be extracted using any suitable feature extraction scheme such as an audio fingerprint method, an MFCC method, etc.

In response to detecting music from the audio stream, the DSP 350 may activate the processor 340, which in turn may allow the music identification unit 342 to identify a piece of music associated with the detected music. At least one sound feature may be extracted from a portion of the audio stream and the piece of music may be identified based on the at least one sound feature. According to some embodiments, the sound processing unit 352 may provide the music identification unit 342 with the at least one sound feature, which has been extracted for detecting music, and the music identification unit 342 may then identify the piece of music based on the at least one sound feature provided from the sound processing unit 352.

In one embodiment, the music identification unit 342 may identify a piece of music associated with the detected music by transmitting the at least one sound feature to an external device (e.g., the server 240 in FIG. 2) via the communication unit 330 through a communication network 390. The external device may include a music database having identification information for a plurality of pieces of music. Upon receiving the at least one sound feature from the electronic device 300, the external device may search the music database for identification information associated with the received sound feature, and transmit the identification information to the electronic device 300. In another embodiment, the storage unit 360 in the electronic device 300 may include a music database (not shown) having identification information for a plurality of pieces of music. In this case, the music identification unit 342 may search the music database in the storage unit 360 for the identification information associated with the sound feature.

The I/O unit 320 may be configured to receive an input from a user of the electronic device 300 and/or output information for the user. The I/O unit 320 may be any suitable device capable of receiving an input command and/or outputting information such as a touchscreen, a touchpad, a touch sensor, a button, a key, a tactile sensor, an illumination sensor, a motion sensor, a microphone, an LCD display, a speaker, and the like. When the identification information is obtained, the music identification unit 342 may provide the identification information or any information related with the identification information to the I/O unit 320. In addition, the I/O unit 320 may also display icons for downloading and sharing the piece of music, for example, as illustrated in FIG. 1. In this case, an input selecting an icon among the displayed icons may be received and a function related to the selected icon may be executed in response to the input.

The location sensor 370 may be configured to obtain location information of the electronic device 300 for use in updating the music history database 364 for an identified piece of music. For example, the location sensor 370 may obtain the location information by determining a location at which the mobile device is located when the piece of music is received or identified (or when identification information for the piece of music is obtained). In determining the location information of the electronic device 300, the location sensor 370 may receive and use GPS location information if such information is available (e.g., in an outdoor setting). If GPS information is not available (e.g., in an indoor setting), the location sensor 370 may receive signals from Wi-Fi access points or cell tower base stations and determine the location of the electronic device 300 based on the intensity of each of the received signals and/or using any suitable triangulation method.

The clock module 380 may be configured to monitor a time at which the piece of music is received or identified. For example, the clock module 380 may record the time at which the identification information for the piece of music is obtained. According to some embodiments, the processor 340, which identifies the piece of music, may include the clock module 380.

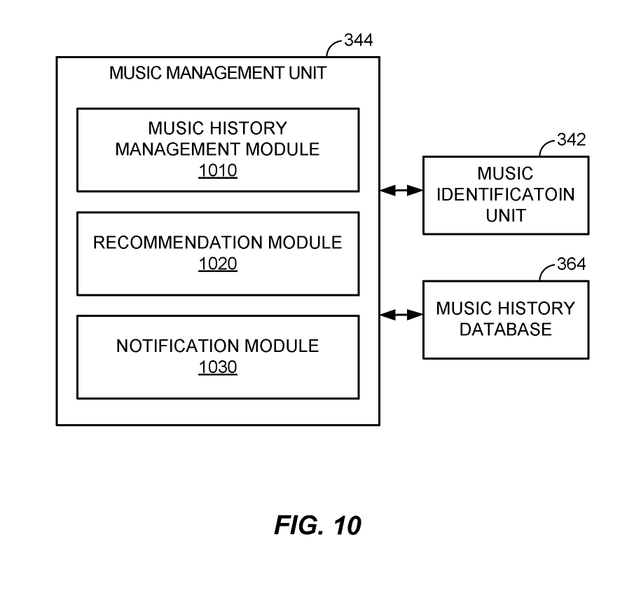

In some embodiments, once the identification information for a piece of music is obtained by the music identification unit 342, it may be provided to the music management unit 344. To keep a record for the piece of music, the music management unit 344 may provide the identification information to the music history database 364 such that the identification information can be stored in the music history database 364. In addition, the music management unit 344 may receive the location information and the time information associated with the piece of music from the location sensor 370 and the clock module 380, respectively, and may store the location information and time information in the music history database 364 along with the identification information for the piece of music. In some embodiments, the identification information, the location information, and/or the time information may be provided directly to the music history database 364, respectively, from the music identification unit 342, the location sensor 370, and/or the clock module 380, not via the music management unit 344. As will be described below in more detail with reference to FIG. 10, the music management unit 344 may also be configured to generate recommendations and notifications for a user of the electronic device 300.

In addition to identifying the piece of music and updating the music history database 364 as described above, when the sound sensor 310 detects music and activates the DSP 350, the sound processing unit 352 in the DSP 350 may generate or obtain a music model for the piece of music which is associated with the detected music. According to one embodiment, the sound processing unit 352 may extract at least one sound feature from a portion of the audio stream and generate the music model for the piece of music based on the at least one sound feature. In this case, a portion of the audio stream may be stored in the buffer memory 354 and at least one sound feature may be extracted from the stored portion in the buffer memory 354. In some embodiments, the sound processing unit 352 may obtain the base music model from the music model database 362 in the storage unit 360 and modify the base music model based on the least one sound feature to generate the music model. According to another embodiment, the sound processing unit 352 may transmit the at least one sound feature to an external device (e.g., the server 240 in FIG. 2) via the communication unit 330 and receive a music model associated with the at least one sound feature in such a manner as described above with reference to FIG. 2. The music model generated or obtained for the piece of music may be stored in the music model database 362.

Once the music model is generated or obtained for the piece of music, the sound processing unit 352 may sample (or receive) at least one portion of the audio stream and determine whether the sampled portion is indicative of the piece of music (i.e., the sampled portion is a portion of the piece of music) based on the music model. For example, if the same piece of music is still being played when the sound processing unit 352 samples a portion of the audio stream, the sampled portion may be determined to be indicative of the piece of music. In this case, the sound processing unit 352 may determine that the piece of music has not ended. On the other hand, if the piece of music has ended when the sound processing unit 352 samples a portion of the audio stream, the sampled portion may be determined not to be indicative of the piece of music. In this case, the sound processing unit 352 may determine that the piece of music has ended. In some embodiments, the sound processing unit 352 may sample a plurality of portions of the audio stream continuously, periodically, aperiodically, or occasionally. In this case, an end of the piece of music may be detected when at least one of the sampled portions (e.g., the last sampled portion) is determined not to be indicative of the piece of music.

Upon determining that the piece of music has ended, the sound sensor 310 may start to receive the input sound stream periodically according to a duty cycle, convert the received input sound stream into the audio stream, and detect sound in the audio stream. Upon detecting the sound in the audio stream, the processor 340 may proceed to detect music for a new piece of music in the audio stream and identify the new piece of music. In addition, a new music model for the new piece of music may be generated or obtained and the new piece of music may be tracked to detect an end of the new piece of music based on the new music model in the manner as described above.

FIG. 4 illustrates a more detailed block diagram of the sound processing unit 352 which is configured to generate or obtain a music model for a piece of music and track the piece of music based on the music model, according to one embodiment of the present disclosure. The sound processing unit 352 may include a music detection module 410, a music model management module 420, and a music tracking module 430. As illustrated in FIG. 4, the sound processing unit 352 may access the buffer memory 354 in the DSP 350 and the music model database 362 in the storage unit 360. When the sound sensor 310 detects sound in the audio stream as described above with reference to FIG. 3, the sound sensor 310 may activate the music detection module 410 of the sound processing unit 352 in the DSP 350.

When activated, the music detection module 410 may receive at least a portion of the audio stream from the sound sensor 310. The music detection module 410 may be configured to detect music in the received portion of the audio stream by using any suitable sound classification method such as a GMM based classifier, a neural network, an HMM (hidden Markov model) based classifier, a graphical model, or an SVM (support vector machine). If the received portion of the audio stream is determined not to be indicative of music, the music detection module 410 may instruct the sound sensor 310 to start to receive the input sound stream periodically according to a duty cycle, convert the received input sound stream into the audio stream, and detect sound in the audio stream in the manner as described above with reference to FIG. 3. In this case, the DSP 350 may be deactivated in order to reduce power consumption. On the other hand, if the received portion of the audio stream is determined to be indicative of music, the music detection module 410 may activate the music model management module 420.

When activated, the music model management module 420 may receive at least a portion of the audio stream from the sound sensor 310. For example, the received portion of the audio stream may be the portion of the audio stream in which music is detected, or a portion following the portion of the audio stream in which music is detected. Based on the received portion of the audio stream, the music model management module 420 may generate a music model for a piece of music which is associated with the music detected by the music detection module 410. In one embodiment, the music model management module 420 may extract at least one sound feature (e.g., an audio fingerprint, an MFCC vector, etc.) from the received portion of the audio stream, and may generate the music model for the piece of music based on the at least one sound feature. The buffer memory 354 may store a portion of the audio stream and the music model management module 420 may access the stored portion in the buffer memory 354 to extract the at least one sound feature for use in generating the music model for the piece of music.

According to some embodiments, the music model database 362 in the storage unit 360 may include a predetermined base music model. In this case, the music model management module 420 may generate the music model for the piece of music by modifying the base music model based on the at least one sound feature extracted from the portion of the audio stream. Once the music model for the piece of music is generated, the music model management module 420 may activate the music tracking module 430 and provide the music model to the music tracking module 430. In one embodiment, the music model management module 420 may store the music model for the piece of music in the music model database 362, such that the music tracking module 430 may access the music model database 362 to obtain the music model for the piece of music. Alternatively or additionally, the music model management module 420 may obtain a music model for the piece of music from an external device (e.g., the server 240 in FIG. 2) in the manner as described above with reference to FIG. 2, and provide the music model to the music tracking module 430.

When activated, the music tracking module 430 may receive a subsequent portion of the audio stream and monitor the received portion based on the music model for the piece of music. In some embodiments, the subsequent portion of the audio stream may be stored in the buffer memory 354 and the music tracking module 430 may access the stored portion of the audio stream in the buffer memory 354. By sampling (or receiving) at least one portion of the audio stream and determining whether or not the sampled portion is indicative of the piece of music (i.e., whether or not the sampled portion is a portion of the piece of music) based on the music model, the music tracking module 430 may track the piece of music and detect an end of the piece of music.

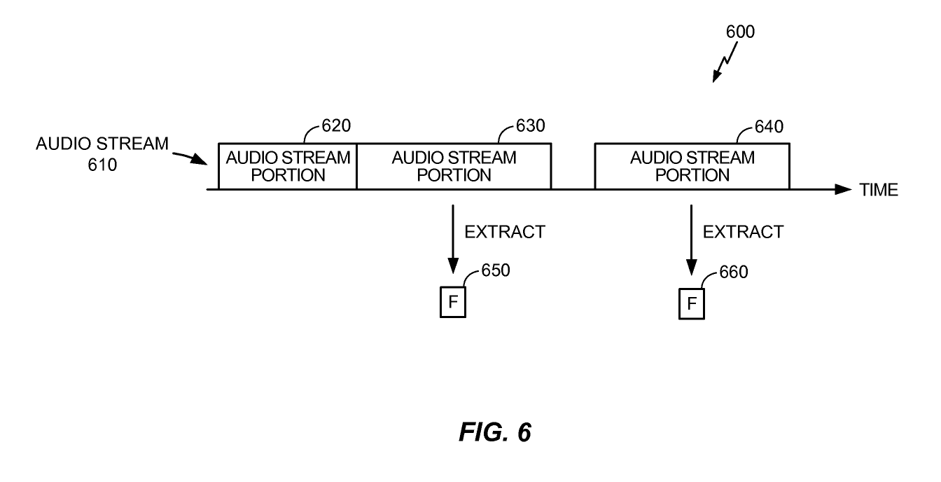

According to some embodiments, the music tracking module 430 may determine a similarity value (or a score) between the piece of music and the sampled portion, based on the music model for the piece of music and at least one sound feature extracted from the sampled portion. In one embodiment, the similarity value may be determined based on a similarity value between the music model and the at least one sound feature extracted from the sampled portion. The schemes for determining the similarity value will be described below in more detail with reference to FIG. 6.

Once the similarity value for the sampled portion is determined, the similarity value may be compared with a predetermined threshold value which may be stored in the storage unit 360. If the similarity value exceeds the threshold value, the sampled portion is determined to be indicative of the piece of music. In this case, the music tracking module 430 may determine that the sampled portion is a portion of the piece of music and the piece of music has not ended. On the other hand, if the similarity value does not exceed the threshold value, the sampled portion may be determined not to be indicative of the piece of music. In this case, the music tracking module 430 may determine that the sampled portion is not a portion of the piece of music and the piece of music has ended. In one embodiment, the music tracking module 430 may sample a plurality of portions of the audio stream continuously, periodically, or aperiodically, and determine whether each of the sampled portions is a portion of the piece of music or not.

Once the sampled portion is determined not to be a portion of the piece of music, the music tracking module 430 may instruct the sound sensor 310 to start to receive the input sound stream periodically according to a duty cycle, convert the received input sound stream into the audio stream, and detect sound in the audio stream. In this case, the DSP 350 may be deactivated in order to reduce power consumption. If sound is detected in the audio stream, the processes of detecting music in the audio stream, generating or obtaining a new music model for a new piece of music, and tracking the new piece of music based on the new music model may be performed in the manner as described above.

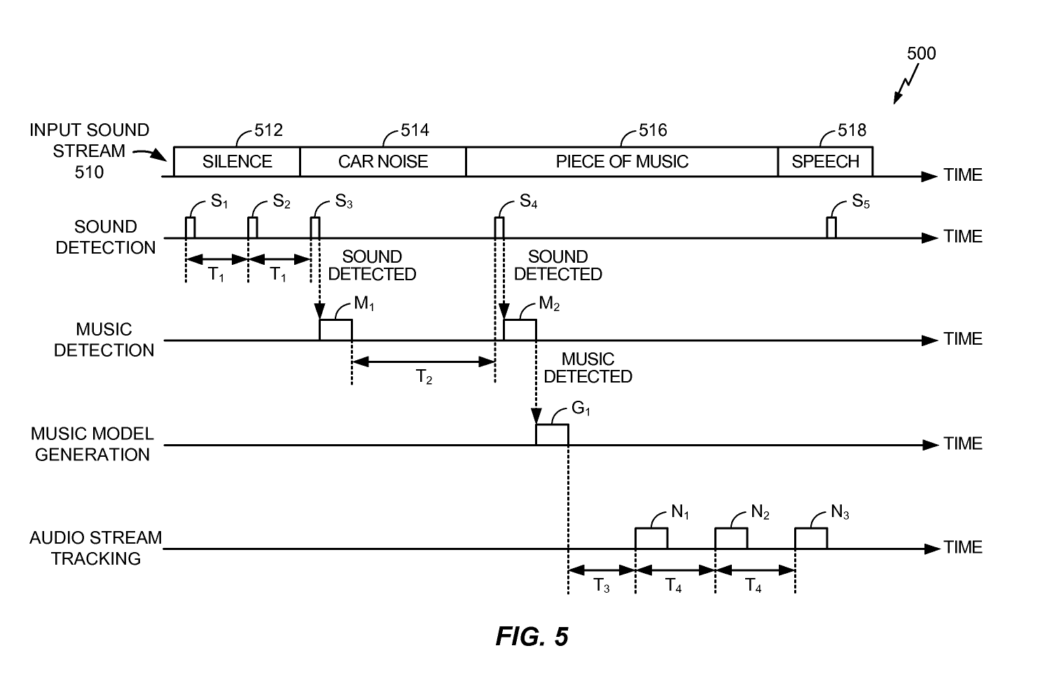

FIG. 5 illustrates a timing diagram 500 for tracking a piece of music 516 in an input sound stream 510 to determine whether the piece of music 516 has ended, according to one embodiment of the present disclosure. For processing the input sound stream 510, the sound sensor 310 of the electronic device 300 may receive the input sound stream 510 that includes a sequence of silence 512, car noise 514, the piece of music 516, and speech 518. In one embodiment, the sound sensor 310 may be configured to receive the input sound stream 510 and convert it into an audio stream that may be processed by the sound processing unit 352.

In some embodiments, the sound sensor 310 may be configured to periodically receive the input sound stream 510 for a predetermined period of time (e.g., any suitable time period between 10 and 30 milliseconds (ms), such as 20 ms, for audio analysis such as a fast Fourier transform) at a predetermined interval T₁ (e.g., any suitable time period between a hundred milliseconds and several seconds, such as 180 ms) according to a predetermined duty cycle. For example, during an active state of the interval T₁, the sound sensor 310 may receive a portion of the input sound stream and convert the received portion into a portion (e.g., S₁, S₂, S₃, or the like) of the audio stream. For each of the audio stream portions such as S₁, S₂, S₃, and the like, the sound sensor 310 may detect sound by determining whether each portion includes sound that exceeds a predetermined threshold sound intensity. According to some embodiments, given that a length of a typical piece of music may be about several minutes (e.g., about three or four minutes), the interval T₁ may be set to be several seconds long. In this case, a missing portion of the input sound stream 510 (i.e., a portion of the input sound stream 510 that is not received by the sound sensor 310) that lasts for several seconds in an inactive state of the interval T₁ may not significantly affect detection of sound in a piece of music. Time periods mentioned herein are just for an exemplary purpose and other periods may also be utilized.

When sound is detected in an audio stream portion S₁, S₂, S₃, or the like, the duty cycle function may be deactivated to allow the sound sensor 310 to continue receiving one or more subsequent portions of the input sound stream 510 and convert the received portions into corresponding one or more audio stream portions. In this case, one or more subsequent portions of the input sound stream may continue to be received and converted into corresponding one or more audio stream portions for use in detecting music associated with the piece of music 516 by the music detection module 410 and, if music is detected, tracking the piece of music 516 for an end of the piece of music 516.

As illustrated in FIG. 5, the sound sensor 310 may receive a plurality of portions of the input sound stream 510, which includes the sequence of the silence 512, the car noise 514, the piece of music 516, and the speech 518, according to the duty cycle. Initially, a portion of the silence 512 in the input sound stream 510 is received during an active state of the interval T₁ and converted into the audio stream portion S₁ by the sound sensor 310. In this case, the sound sensor 310 may not detect sound from the audio stream portion S₁ and is deactivated during an inactive state of the interval T₁. At the end of the interval T₁, the sound sensor 310 may be activated to receive another portion of the silence 512 in the input sound stream 510 and convert the received portion into the audio stream portion S₂. Since the audio stream portion S₂ corresponds to a portion of the silence 512, sound may not be detected by the sound sensor 310.

During a next active state of the interval T₁, the sound sensor 310 may be activated to receive a portion of the car noise 514 in the input sound stream 510 and convert the received portion into the audio stream portion S₃. In this case, the sound sensor 310 may determine that the audio stream portion S₃ exceeds the predetermined threshold sound intensity and thus detect sound in the audio stream portion S₃. Upon detecting sound in the audio stream portion S₃, the sound sensor 310 may deactivate the duty cycle function to receive a following portion of the input sound stream 510 and convert the received portion into an audio stream portion denoted as M₁. In addition, the sound sensor 310 may activate the music detection module 410 in the sound processing unit 352 of the DSP 350 and provide the audio stream portion M₁ to the music detection module 410.

The music detection module 410, when activated, may be configured to receive a portion of the audio stream for a predetermined time period (e.g., 10 seconds) as denoted by M₁ or M₂. In the illustrated embodiment, when the sound sensor 310 detects sound in the audio stream portion S₃, the music detection module 410 may receive the audio stream portion M₁ corresponding to a portion of the car noise 514, and may determine that the audio stream portion M₁ does not include music. In this case, the music detection module 410 may deactivate the sound sensor 310 to discontinue receiving the input sound stream 510 for a predetermined time period T₂. In one embodiment, the music detection module 410 may be deactivated to reduce power consumption when music is not detected. Given that a piece of music may typically be several minutes long, the time period T₂, which may be longer than the interval T₁, may be any suitable time period between, for example, 10 and 30 seconds, since the deactivation of the sound sensor 310 and the music detection module 410 for such a period of time may not significantly affect detection of sound and music in a piece of music.

When the predetermined time period T₂ has elapsed, the sound sensor 310 may be activated according to the duty cycle to receive a portion of the piece of music 516 in the input sound stream 510 and convert the received portion of the piece of music 516 into an audio stream portion S₄. The sound sensor 310 may detect sound in the audio stream portion S₄ corresponding to a portion of the piece of music 516 by determining that the audio stream portion S₄ includes sound exceeding the predetermined threshold sound intensity. Upon detecting sound in the audio stream portion S₄, the sound sensor 310 may deactivate the duty cycle function to receive a following portion of the input sound stream 510 and convert the received portion into the audio stream portion denoted as M₂. Additionally, the sound sensor 310 may activate the music detection module 410 and provide the audio stream portion M₂ to the music detection module 410. In some embodiments, the sound sensor 310 may continue to receive one or more subsequent portions of the input sound stream 510 and convert the portions into audio stream portions (e.g., G₁, N₁, N₂, N₃, etc.) until it is determined that the audio stream portion M₂ does not include music or that an audio stream portion corresponding to one of the subsequent portions of the input sound stream 510 is not a portion of the piece of music 516.

Upon being activated, the music detection module 410 may receive the audio stream portion M₂ corresponding to a portion of the piece of music 516 from the sound sensor 310, and may detect music in the audio stream portion M₂. In response to detecting music in the audio stream portion M₂, the music model management module 420 may be activated to receive the audio stream portion G₁ for a predetermined time period (e.g., 10 seconds) that follows the audio stream portion M₂ of the piece of music 516. Based on the audio stream portion G₁ and/or any other portions, the music model management module 420 may generate or obtain a music model for the piece of music 516 as described above with reference to FIG. 4. In one embodiment, the music model management module 420 may extract at least one sound feature from the audio stream portion G₁ and generate the music model for the piece of music 516 based on the at least one sound feature. In another embodiment, the music model for the piece of music, which is associated with the sound feature extracted from the audio stream portion G₁, may be received from an external device, in the manner as described above with reference to FIG. 2.

When a predetermined time period T₃ has elapsed after generating or obtaining the music model based on the audio stream portion G₁, the music tracking module 430 may be activated to track the piece of music 516 by periodically sampling one or more subsequent audio stream portions (e.g., N₁, N₂, and N₃) at a predetermined interval T₄ (e.g., any suitable time period between 2 and 30 seconds). In some embodiments, after the end of the time period T₃, the music tracking module 430 may be configured to receive an audio stream portion (e.g., N₁, N₂, or N₃) from the sound sensor 310 for a predetermined time period (e.g., 10 seconds). Although the music model is described above as being generated or obtained based on the sound feature extracted from the audio stream portion G₁ in FIG. 5, the music model may be generated or obtained based on the sound feature extracted from the audio stream portion M₂, which has been used for detecting music. In this case, the predetermined time period T₃ may start at the end of the time period corresponding to the audio stream portion M₂.

When an audio stream portion is received at the beginning of the interval T₄ for tracking, the music tracking module 430 may determine whether or not the audio stream portion is indicative of the piece of music 516 (i.e., the audio stream portion is a portion of the piece of music 516) based on the music model associated with the piece of music 516. If the audio stream portion is determined not to be a portion of the piece of music 516, the music tracking module 430 may determine that the piece of music 516 has ended. In this case, the music tracking module 430 (or the DSP 350, or the processor 340) may generate one or more interrupt signals for detecting sound and music in the audio stream, identifying a next piece of music and/or tracking the next piece of music. For example, the music tracking module 430 may generate an interrupt signal and provide the interrupt signal to the sound sensor 310 for receiving the input sound stream 510 according to a duty cycle and detecting sound in the audio stream generated from the input sound stream. On the other hand, if the audio stream portion is determined to be a portion of the piece of music 516 indicating that the piece of music 516 has not ended, the music tracking module 430 may receive a next audio stream portion at the end of the interval T₄. In this case, the music tracking module 430 (or the DSP 350, or the processor 340) may not generate an interrupt signals for identifying a piece of music.

In the illustrated embodiment, the music tracking module 430 may receive the audio stream portion N₁ corresponding to a portion of the piece of music 516 and determine that the audio stream portion N₁ is a portion of the piece of music 516 based on the music model. At the end of the interval T₄, the audio stream portion N₂, which corresponds to a subsequent portion of the piece of music 516, may be received by the music tracking module 430, which may determine that the audio stream portion N₂ is a portion of the piece of music 516 by using the music model. At the beginning of the next interval T₄, the music tracking module 430 may receive the audio stream portion N₃, which corresponds to a portion of the speech 518 in the input sound stream 510. Since the audio stream portion N₃ corresponds to the portion of the speech 518, the music tracking module 430, or alternatively music detection module 410, may determine, based on the music model, that the audio stream portion N₃ is not a portion of the piece of music 516, indicating that the piece of music 516 has ended. As described above, the audio stream portions (i.e., N₁, N₂, N₃, etc.) are used in tracking the piece of music 516 to determine whether or not the piece of music 516 has ended. Thus, even if the first audio stream portion (i.e., N₁) is received after the end of the piece of music 516, it may not have significant effects on determining that the received audio stream portion is not a portion of the piece of music 516, indicating that the piece of music 516 has ended. Accordingly, the time period T₃ may be any suitable time period longer than the time period T₂, such as between 5 seconds 5 minutes.

Once the audio stream portion N₃ is determined not to be a portion of the piece of music 516 (i.e., the piece of music 516 has ended or no longer detectable by the sound sensor 310), the music tracking module 430 may activate the sound sensor 310 to start receiving one or more portions of the input sound stream 510 periodically according to the duty cycle. In the embodiment shown in FIG. 5, the sound sensor 310 may receive a portion of the speech 518 in the input sound stream 510 and convert the received portion into an audio stream portion S₅. In this case, the sound sensor 310 may determine that the audio stream portion S₅ includes sound exceeding the predetermined threshold sound intensity. Upon detecting sound, the music detection module 410 may be activated to receive a subsequent audio stream portion and determine that the audio stream portion does not include music. The processing of subsequent portions of the input sound stream 510 or other input sound streams may be performed by the sound sensor 310, the music detection module 410, the music model management module 420, and/or the music tracking module 430 in a similar manner as described above. Although the above embodiments are described, by way of examples, with specific time parameters and/or ranges for the time periods or intervals such as T₁, T₂, T₃, T₄, and the like, the time periods may not be limited to such time parameters and ranges, but may be set to be any other suitable time parameters and/or ranges. In addition, the time periods may be adjusted as necessary according to various implementations (e.g., a battery power of the electronic device 300, computational resources and power of the electronic device 300, an expected length of the piece of music 516, etc.).

FIG. 6 illustrates a timing diagram 600 for sampling an audio stream portion 630 of a piece of music in an audio stream 610 and determining whether a subsequent portion 640 in the audio stream 610 is a portion of the piece of music, according to one embodiment of the present disclosure. Initially, music may be detected in a portion 620 of the audio stream 610 that precedes or is immediately prior to the audio stream portion 630. Upon detecting the music, the music model management module 420 may extract at least one sound feature 650 from the audio stream portion 630 and generate or obtain a music model for the piece of music associated with the portion 620.

The music model for the piece of music may then be provided to the music tracking module 430 for use in tracking the piece of music. The music tracking module 430 may sample the subsequent portion 640 in the audio stream 610 and extract at least one sound feature 660 from the sampled audio stream portion 640. Based on the music model and the sound feature 660, it may be determined whether the sampled audio stream portion 640 is a portion of the piece of music. According to some embodiments, the music tracking module 430 may determine a similarity between the sampled audio stream portion 640 and the music model for the piece of music. For example, a similarity value (e.g., a score, a confidence value, or the like) indicative of a degree of similarity between the sampled audio stream portion 640 and the music model may be calculated. If the similarity value exceeds a predetermined threshold value, the sampled audio stream portion 640 may be determined to be a portion of the piece of music, indicating that the piece of music has not ended. On the other hand, if the similarity value does not exceed the threshold value, it may be determined that the sampled audio stream portion 640 is not a portion of the piece of music, indicating that the piece of music has ended.

In one embodiment, a similarity value between the audio stream portion 640 and the music model for the piece of music may be determined based on probability values (e.g., likelihood values). For example, a first probability value indicating a likelihood that the at least one sound feature 660 extracted from the audio stream portion 640 is indicative of the music model may be determined. Additionally, a second probability value indicating a likelihood that the at least one sound feature 660 is indicative of a base music model may be determined. Upon determining the first and second probability values, the similarity value between the audio stream portion 640 and the music model for the piece of music may be determined by subtracting the second probability value from the first probability value, which may be expressed by the following equation:

Similarity Value=L(xₛₐₘₚₗₑ|λ_{music})−L(xₛₐₘₚₗₑ|λ_{base})

where xₛₐₘₚₗₑ denotes the at least one sound feature 660 extracted from the audio stream portion 640, λ_{music} denotes the music model associated with the piece of music, λ_{base} denotes the base music model, L(xₛₐₘₚₗₑ|λ_{music}) denotes the first probability value (e.g., a log likelihood of xₛₐₘₚₗₑ given λ_{music}), and L(xₛₐₘₚₗₑ|λ_{base}) denotes the second probability value (e.g., a log likelihood of xₛₐₘₚₗₑ given) λ_{base}).

In another embodiment, the similarity value may be determined using the Bayesian information criterion. As described above, the music model for the piece of music may be generated or obtained based on the at least one sound feature 650 extracted from the audio stream portion 630. In addition, another music model may be generated or obtained based on the at least one sound feature 660 extracted from the sampled audio stream portion 640. For example, the music model for the audio stream portion 640 may be generated by modifying the base music model based on the at least one sound feature 660. According to this embodiment, a first probability value indicating a likelihood that the at least one sound feature 650 is indicative of the music model for the piece of music may be determined. Further, a second probability value indicating a likelihood that the at least one sound feature 660 is indicative of the other music model for the sampled audio stream portion 640 may be determined. Furthermore, a third probability value indicating a likelihood that the sound features 650 and 660 are indicative of the base music model may be determined. Upon determining the first to third probability values, the similarity value may be determined by subtracting the third probability value from the sum of the first and second probability values, which may be expressed by the following equation:

Similarity Value=L(x_{music}|λ_{music})+L(xₛₐₘₚₗₑ|λₛₐₘₚₗₑ)−L(x_{music},xₛₐₘₚₗₑ|λ_{base})

where x_{music} denotes the at least one sound feature 650 extracted from the audio stream portion 630, xₛₐₘₚₗₑ denotes the at least one sound feature 660 from the sampled audio stream portion 640, λ_{music} denotes the music model associated with the piece of music, λₛₐₘₚₗₑ denotes the music model associated with the audio stream portion 640, λ_{base} denotes the base music model, L(x_{music}|λ_{music}) denotes the first probability value (e.g., a log likelihood of x_{music} given λ_{music}), L(xₛₐₘₚₗₑ|λₛₐₘₚₗₑ) denotes the second probability value (e.g., a log likelihood of xₛₐₘₚₗₑ given λₛₐₘₚₗₑ), and L(x_{music}, xₛₐₘₚₗₑ|λ_{base}) denotes the third probability value (e.g., a log likelihood of x_{music} and xₛₐₘₚₗₑ given λ_{base}).

In the above embodiment, to improve efficiency of computational resources and power, the music model for the sampled audio stream portion 640 may be generated by modifying the base music model when each sound feature is extracted from the sampled audio stream portion 630. Alternatively, the base music model may be modified once based on all of the extracted sound features. Also, to improve the efficiency in determining the first or third probability value, when a plurality of sound features has been extracted from the audio stream portion 630, a subset of the plurality of sound features may be selected and stored for use in determining the third probability value. For example, the subset of the sound features may be selected based on the likelihood that each sound feature is music.

In still another embodiment, the similarity value may be determined using a cross likelihood ratio method. According to this embodiment, a first probability value indicating a likelihood that the at least one sound feature 660 extracted from the audio stream portion 640 is indicative of the music model for the piece of music may be determined. Additionally, a second probability value indicating a likelihood that the at least one sound feature 650 extracted from the audio stream portion 630 is indicative of the music model for the audio stream portion 640 may be determined. Further, a third probability value indicating a likelihood that the at least one sound feature 650 is indicative of the base music model and a fourth probability value indicating a likelihood that the at least one sound feature 660 is indicative of the base music model may also be determined. Upon determining the first to fourth probability values, the similarity value may be determined by subtracting the third and fourth probability values from the sum of the first and second probability values, which may be expressed by the following equation:

Similarity Value=L(xₛₐₘₚₗₑ|λₛₐₘₚₗₑ)+L(x_{music}|λ_{music})−L(x_{music}|λ_{base})−L(xₛₐₘₚₗₑ|λ_{base})

where xₛₐₘₚₗₑ denotes the at least one sound feature 660 extracted from the audio stream portion 640, x_{music} denotes the at least one sound feature 650 extracted from the audio stream portion 630, λ_{music} denotes the music model associated with the piece of music, λₛₐₘₚₗₑ denotes the music model associated with the audio stream portion 640, λ_{base} denotes the base music model, L(xₛₐₘₚₗₑ|λ_{music}) denotes the first probability value (e.g., a log likelihood of xₛₐₘₚₗₑ given λ_{music}), L(xₛₐₘₚₗₑ|λₛₐₘₚₗₑ) denotes the second probability value (e.g., a log likelihood of x_{music} given λₛₐₘₚₗₑ), L(x_{music}|λ_{base}) denotes the third probability value (e.g., a log likelihood of x_{music} given λ_{base}), and L(xₛₐₘₚₗₑ|λ_{base}) denotes the fourth probability value (e.g., a log likelihood of xₛₐₘₚₗₑ given λ_{base}). For efficiency of computational resources and power, the third probability value may be determined in advance prior to determining the similarity value.

In yet another embodiment, the similarity value may be determined based on distance values between music models. For example, Euclidean distances, Hamming distances, Kullback-Leibler (KL) divergence, and the like may be calculated as the distance values between music models. In this embodiment, a first distance value between the music model for the audio stream portion 640 and the music model for the piece of music may be determined. In addition, a second distance value between the music model for the piece of music and the base music model may be determined, and a third distance value between the music model for the audio stream portion 640 and the base music model may be determined. Upon determining the first to third distance values, the similarity value may be determined by subtracting the second and third distance values from a doubled value of the first distance value, which may be expressed by the following equation:

Similarity Value=2·D(λₛₐₘₚₗₑ,λ_{music})−D(λ_{music},λ_{base})−D(λₛₐₘₚₗₑ,λ_{base})

where λₛₐₘₚₗₑ denotes the music model for the audio stream portion 640, λ_{music} denotes the music model for the piece of music, λ_{base} denotes the base music model, D(λₛₐₘₚₗₑ, λ_{music}) denotes the first distance value between λₛₐₘₚₗₑ and λ_{music}, D(λ_{music}, λ_{base}) denotes the second distance value between λ_{music} and λ_{base}, and D(λₛₐₘₚₗₑ, λ_{base}) denotes the third distance value between λₛₐₘₚₗₑ and λ_{base}. In the above described embodiments for determining the similarity value, any suitable modifications may be made in order to improve efficiency of computational resources and power.

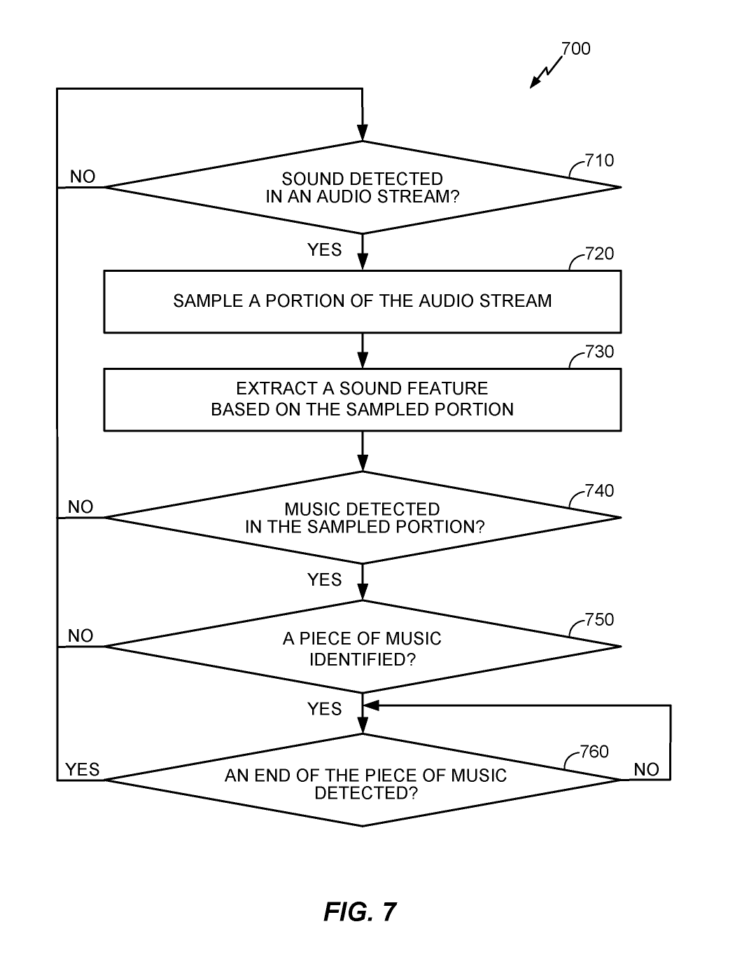

FIG. 7 is a flowchart of a method 700, performed in an electronic device, for identifying and tracking a piece of music in an audio stream, according to one embodiment of the present disclosure. The electronic device (e.g., the electronic device 300 shown in FIG. 3) may receive an input sound stream that includes sounds corresponding to a piece of music and convert the input sound stream into an audio stream. At 710, the electronic device may determine whether sound is detected in the audio stream. In one embodiment, sound may be detected in the audio stream based on a threshold sound intensity. If sound is not detected (i.e., “NO” at 710), the method 700 may proceed back to 710 to determine whether sound is detected in the audio stream being generated from the input sound stream being received.

When sound is detected (i.e., “YES” at 710), the electronic device may sample a portion of the audio stream, at 720, and extract a sound feature based on the sampled portion of the audio stream, at 730. In some embodiments, a plurality of sound features may be extracted from the sampled portion of the audio stream. Based on the sound feature, the electronic device may determine whether music is detected in the sampled portion of the audio stream, at 740, by using any suitable sound classification method. If music is not detected (i.e., “NO” at 740), the method 700 may proceed back to 710 to continue to determine whether sound is detected in the audio stream being generated.

On the other hand, when music is detected (i.e., “YES” at 740), the method 700 may proceed to 750 to identify a piece of music, which is associated with the detected music. According to some embodiments, the piece of music may be identified by obtaining identification information associated with the piece of music. If the electronic device fails to identify the piece of music (i.e., “NO” at 750), the method 700 may proceed back to 710 to determine whether sound is detected in the audio stream being generated.

On the other hand, if the piece of music is identified (i.e., “YES” at 750), a music history database in the electronic device may be updated with the identified piece of music. Additionally, the method 700 may proceed to 760 to track the identified piece of music and detect an end of the piece of music. According to some embodiments, the electronic device may sample a portion of the audio stream and determine whether or not the sampled portion is a portion of the piece of music. In this process, a music model for the piece of music, which is generated in the electronic device or obtained from an external device, may be used. If the end of the piece of music is not detected (i.e., “NO” at 760), the method 700 proceeds to keep tracking the piece of music, for example, by sampling a next portion of the audio stream. Otherwise, if the end of the piece of music is detected (i.e., “YES” at 760), the method 700 may proceed back to 710 to determine whether sound is detected in the audio stream being generated. Although the method 700 is described above as tracking the piece of music after obtaining the identification information for the piece of music, even if the electronic device fails to obtain such identification information, the method 700 may generate or obtain a music model for a piece of music based on a portion of the audio stream and track the piece of music based on the music model.

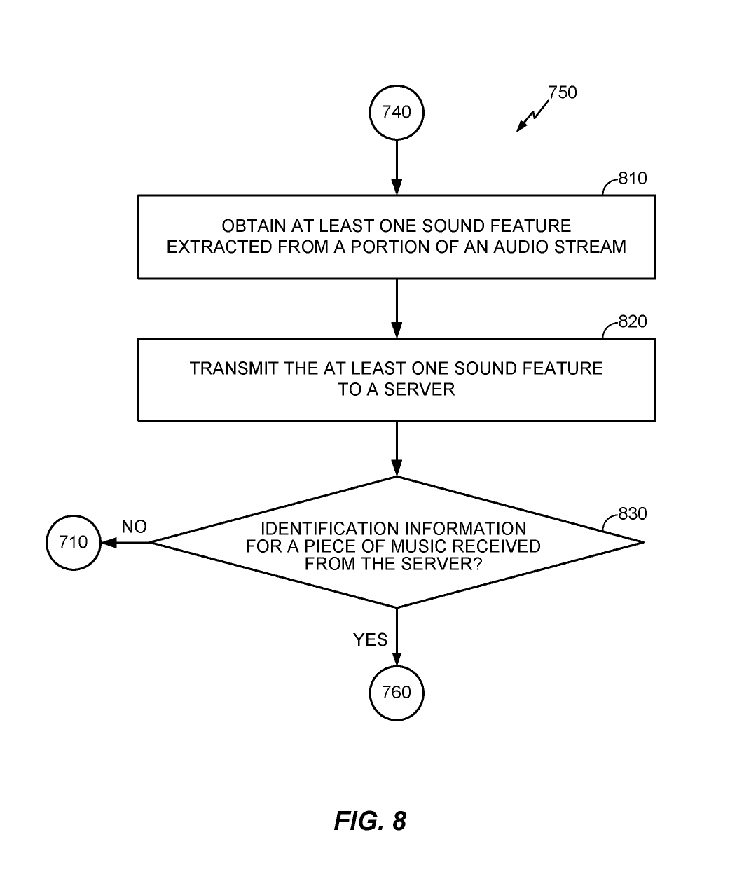

FIG. 8 illustrates a detailed method 750 for identifying a piece of music based on at least one sound feature extracted from a portion of an audio stream, according to one embodiment of the present disclosure. Once music is detected in a sampled portion of an audio stream, at 740 in FIG. 7, the method 750 may obtain at least one sound feature that is extracted from a portion of the audio stream, at 810. In one embodiment, the music detection module 410 may provide at least one sound feature, which has been extracted from a portion of the audio stream and used for detecting music, to the music identification unit 342. In another embodiment, the music identification unit 342 may extract at least one sound feature from a portion of the audio stream, which is subsequent to the portion where the music detection module 410 has extracted the sound feature for detecting music.

The obtained at least one sound feature may be transmitted from an electronic device (e.g., the electronic device 300 in FIG. 3) to a server (e.g., the server 240 in FIG. 2), at 820. The server may store a music database that includes identification information. Based on the sound feature from the electronic device, the server may retrieve identification information associated with a piece of music corresponding to the sound feature. If the server fails to retrieve such identification information for the sound feature, the server may transmit a message indicating that no match was found to the electronic device. On the other hand, if the server succeeds in retrieving the identification information for the sound feature, the server may transmit the retrieved identification information associated with the piece of music to the electronic device.

At 830, the method 750 may determine whether the identification information for the piece of music is received from the server. When the identification information associated with the piece of music is received from the server (i.e., “YES” at 830), the method 750 proceeds to 760 to track the piece of music and detect an end of the piece of music. If no identification information is received (e.g., a message indicating that no match was found is received) from the server (i.e., “No” at 830), the method 750 proceeds to 710 to determine whether sound is detected in the audio stream being generated. According to one embodiment, the server may include a plurality of music models for a plurality of pieces of music and transmit one of the plurality of music models, which matches the sound feature received from the electronic device, to the electronic device.

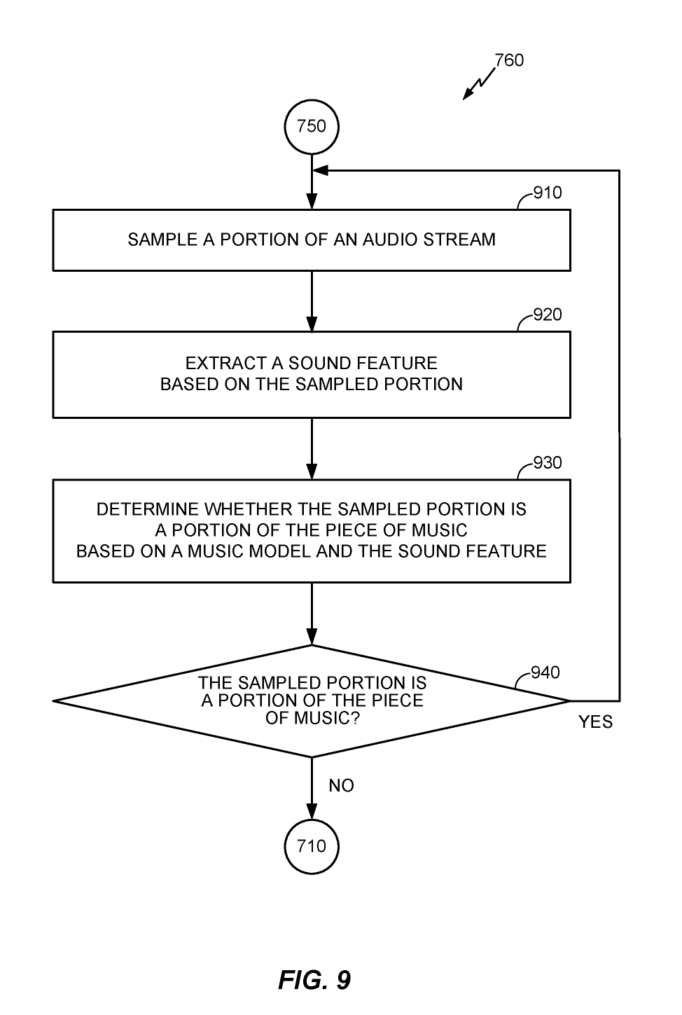

FIG. 9 illustrates a detailed method 760 for tracking a piece of music based on a music model associated with the piece of music, according to one embodiment of the present disclosure. The method 760 may sample a portion of an audio stream, at 910. The portion may be sampled after a predetermined period of time (e.g., T₃ in FIG. 5) since a portion (e.g., G₁ in FIG. 5) of the audio stream has been sampled for detecting music, or after another predetermined period of time (e.g., T₄ in FIG. 5) after a portion (e.g., N₁ in FIG. 5) of the audio stream has been sampled for detecting an end of the piece of music. Further, the method 760 may extract a sound feature based on the sampled portion of the audio stream, at 920. In some embodiments, a plurality of sound features may be extracted from the sampled portion of the audio stream.

The method 750 may determine whether the sampled portion of the audio stream is a portion of the piece of music based on a music model for the piece of music and the extracted sound feature, at 930. The music model for the piece of music may be generated in an electronic device or received from an external device. In some embodiments, the music tracking module 430 in the electronic device may determine a similarity value between the sound feature and the music model for the piece of music. The similarity value may be determined by using any suitable scheme, for example, in the manner as described above with reference to FIG. 6. The similarity value may be compared with a predetermined threshold value.

If the sampled portion is determined not to be a portion of the piece of music (i.e., “NO” at 940), the method 760 proceeds to 710 to continue to determine whether sound is detected in the audio stream being generated. On the other hand, if the sampled portion is determined to be a portion of the piece of music (i.e., “YES” at 940), the method 760 proceeds to 910 to sample a next portion of the audio stream. In this manner, the music tracking module 430 may continue to track the piece of music.

FIG. 10 illustrates a more detailed block diagram of the music management unit 344 in the processor 340 of the electronic device 300 configured to receive identification information for a piece of music, manage the music history database 364, and generate recommendations and notifications, according to one embodiment of the present disclosure. The music management unit 344 may include a music history management module 1010, a recommendation module 1020, and a notification module 1030. As shown, the music management unit 344 may access the music identification unit 342 in the processor 340 and the music history database 364 in the storage unit 360.

Once the music identification unit 342 obtains identification information for a piece of music, it may provide the identification information to the music history management module 1010 in the music management unit 344. The music history management module 1010 may access and update the music history database 364 with the identification information. Additionally, the music history management module 1010 may instruct the location sensor 370 and the clock module 380 to determine location information of the electronic device 300 and time information for use in updating the music history database. The location and time information may be stored along with the identification information for the piece of music in the music history database 364.

In one embodiment, the music history management module 1010 may generate a list of frequently-heard pieces of music based on the identification information stored in the music history database 364. For example, the music history management module 1010 may determine how many times a piece of music is recorded in the music history database 364 within a prescribed time interval. When the piece of music is identified more than a predetermined number of times, the music history management module 1010 may determine that the piece of music is a frequently-heard piece of music and add it to the list of frequently-heard pieces of music. Further, the music history management module 1010 may generate a list of pieces of music heard in one or more time periods or locations together with the times or locations associated with the pieces of music.

Based on the identification information stored in the music history database 364, the recommendation module 1020 may generate a recommendation for a user. For example, when the identified piece of music is included in the list of frequently-heard pieces of music, the recommendation module 1020 may generate and display a recommendation for a user to download or purchase the identified piece of music on the I/O unit 320. Additionally or alternatively, the recommendation module 1020 may provide a recommendation for streaming the pieces of music in the list of frequently-heard pieces of music from an external server.

The notification module 1030 may be configured to analyze the identification information and provide a notification for the identified piece of music. For example, identification information may include additional information indicating that the piece of music is available for free download or associated with a particular type of music video such as a funny music video, a highly rated music video. In this case, the notification unit 460 may notify the user of the additional information. In some embodiments, when the identified piece of music is determined as a “favorite music” of another user, the notification module 1030 may notify the user that the identified piece of music is the other user's favorite music.

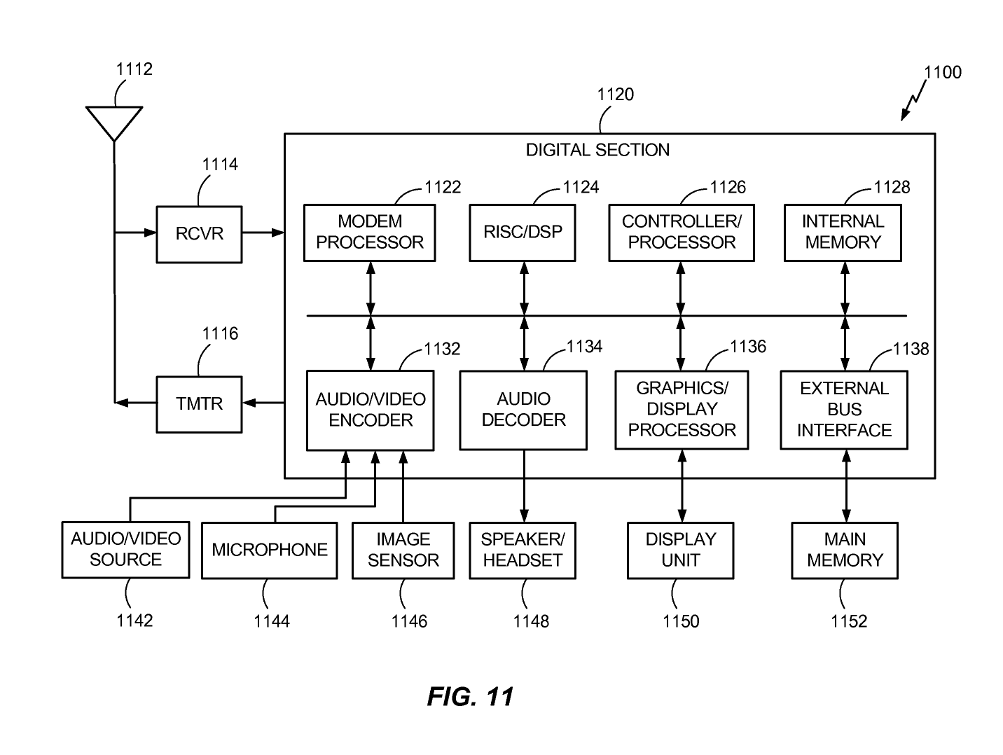

FIG. 11 illustrates a block diagram of a mobile device 1100 in a wireless communication system in which the methods and apparatus of the present disclosure for identifying a piece of music from an audio stream and tracking the piece of music may be implemented according to some embodiments. The mobile device 1100 may be a cellular phone, a smartphone, a wearable computer, a smart watch, smart glasses, a tablet personal computer, a terminal, a handset, a personal digital assistant (PDA), a wireless modem, a cordless phone, a tablet, and so on. The wireless communication system may be a CDMA system, a GSM system, a W-CDMA system, a LTE system, a LTE Advanced system, and so on.

The mobile device 1100 may be capable of providing bidirectional communication via a receive path and a transmit path. On the receive path, signals transmitted by base stations may be received by an antenna 1112 and may be provided to a receiver (RCVR) 1114. The receiver 1114 may condition and digitize the received signal, and provide the conditioned and digitized digital signal to a digital section for further processing. On the transmit path, a transmitter (TMTR) 1116 may receive data to be transmitted from a digital section 1120, process and condition the data, and generate a modulated signal, which is transmitted via the antenna 1112 to the base stations. The receiver 1114 and the transmitter 1116 may be part of a transceiver that may support CDMA, GSM, W-CDMA, LTE, LTE Advanced, and so on.

The digital section 1120 may include various processing, interface, and memory units such as, for example, a modem processor 1122, a reduced instruction set computer/digital signal processor (RISC/DSP) 1124, a controller/processor 1126, an internal memory 1128, a generalized audio/video encoder 1132, a generalized audio decoder 1134, a graphics/display processor 1136, and an external bus interface (EBI) 1138. The modem processor 1122 may perform processing for data transmission and reception, e.g., encoding, modulation, demodulation, and decoding. The RISC/DSP 1124 may perform general and specialized processing for the mobile device 1100. The controller/processor 1126 may perform the operation of various processing and interface units within the digital section 1120. The internal memory 1128 may store data and/or instructions for various units within the digital section 1120.

The generalized audio/video encoder 1132 may perform encoding for input signals from an audio/video source 1142, a microphone 1144, an image sensor 1146, etc. The generalized audio decoder 1134 may perform decoding for coded audio data and may provide output signals to a speaker/headset 1148. The graphics/display processor 1136 may perform processing for graphics, videos, images, and texts, which may be presented to a display unit 1150. The EBI 1138 may facilitate transfer of data between the digital section 1120 and a main memory 1152.

The digital section 1120 may be implemented with one or more processors, DSPs, microprocessors, RISCs, etc. The digital section 1120 may also be fabricated on one or more application specific integrated circuits (ASICs) and/or some other type of integrated circuits (ICs).

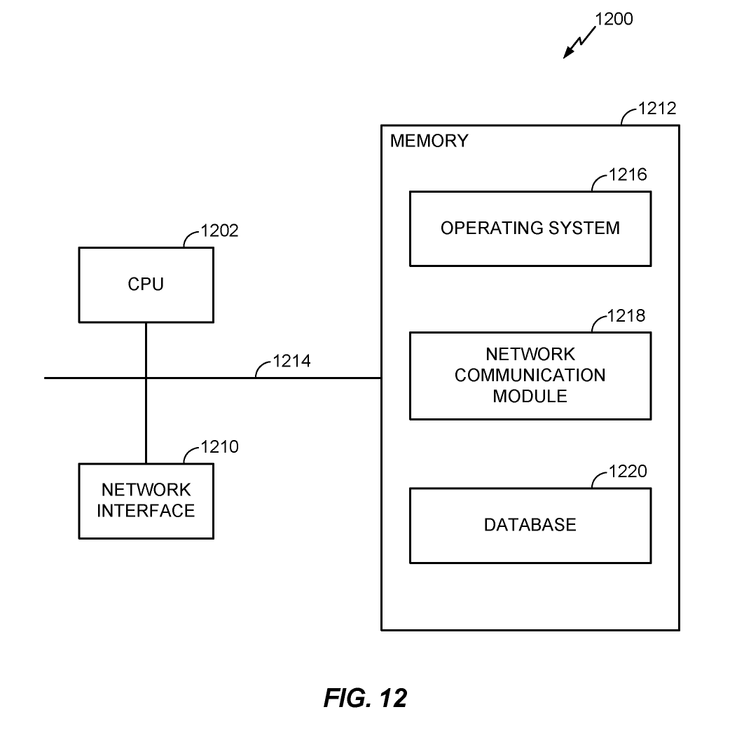

FIG. 12 is a block diagram illustrating a server system 1200, which may be any one of the servers previously described, for searching and providing information on a piece of music implemented according to some embodiments. The server system 1200 may include one or more processing units (e.g., CPUs) 1202, one or more network or other communications network interfaces, a memory 1212, and one or more communication buses 1214 for interconnecting these components. The server system 1200 may also include a user interface (not shown) having a display device and a keyboard.

The memory 1212 may be any suitable memory, such as a high-speed random access memory, (e.g., DRAM, SRAM, DDR RAM or other random access solid state memory devices). The memory 1212 may include or may alternatively be non-volatile memory (e.g., one or more magnetic disk storage devices, optical disk storage devices, flash memory devices, or other non-volatile solid state storage devices). In some embodiments, the memory 1212 may include one or more storage devices remotely located from the CPU(s) 1202 and/or remotely located in multiple sites.

Any one of the above memory devices represented by the memory 1212 may store any number of modules or programs that corresponds to a set of instructions for performing and/or executing any of the processes, operations, and methods previously described. For example, the memory 1212 may include an operating system 1216 configured to store instructions that includes procedures for handling various basic system services and for performing hardware dependent tasks. A network communication module 1218 of the memory 1212 may be used for connecting the server system 1200 to other computers via the one or more communication network interfaces 1210 (wired or wireless) and one or more communication networks, such as the Internet, other wide area networks, local area networks, metropolitan area networks, and so on.

The memory 1212 may also include a music database 1220 configured to include a music model database, an identification information database, and the like. Each of the databases in the music database may be used for identifying a piece of music and detecting an end of a piece of music. Each music model in the music model database may be associated with a piece of music. The operating system 1216 may update the music database 1220 with various music in multimedia streams received from a plurality of music providers through the network communication module 1218. The operating system 1216 may also provide the music model and identification information for a plurality of pieces of music to a plurality of electronic devices via the network communication module 1218.

In general, any device described herein may represent various types of devices, such as a wireless phone, a cellular phone, a laptop computer, a wireless multimedia device, a wireless communication personal computer (PC) card, a PDA, an external or internal modem, a device that communicates through a wireless channel, etc. A device may have various names, such as access terminal (AT), access unit, subscriber unit, mobile station, mobile device, mobile unit, mobile phone, mobile, remote station, remote terminal, remote unit, user device, user equipment, handheld device, etc. Any device described herein may have a memory for storing instructions and data, as well as hardware, software, firmware, or combinations thereof

The techniques described herein may be implemented by various means. For example, these techniques may be implemented in hardware, firmware, software, or a combination thereof. Those of ordinary skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, the various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

For a hardware implementation, the processing units used to perform the techniques may be implemented within one or more ASICs, DSPs, digital signal processing devices (DSPDs), programmable logic devices (PLDs), field programmable gate arrays (FPGAs), processors, controllers, micro-controllers, microprocessors, electronic devices, other electronic units designed to perform the functions described herein, a computer, or a combination thereof

Thus, the various illustrative logical blocks, modules, and circuits described in connection with the disclosure herein are implemented or performed with a general-purpose processor, a DSP, an ASIC, a FPGA or other programmable logic device, discrete gate or transistor logic, discrete hardware components, or any combination thereof designed to perform the functions described herein. A general-purpose processor may be a microprocessor, but in the alternate, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in software, the functions may be stored on or transmitted over as one or more instructions or code on a computer-readable medium. Computer-readable media include both computer storage media and communication media including any medium that facilitates the transfer of a computer program from one place to another. A storage media may be any available media that can be accessed by a computer. By way of example, and not limited thereto, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein are applied to other variations without departing from the spirit or scope of the disclosure. Thus, the disclosure is not intended to be limited to the examples described herein but is to be accorded the widest scope consistent with the principles and novel features disclosed herein.

Although exemplary implementations are referred to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices may include PCs, network servers, and handheld devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be appreciated that the above identified modules or programs (i.e., sets of instructions) need not be implemented as separate software programs, procedures or modules, and thus various subsets of these modules may be combined or otherwise re-arranged in various embodiments. Furthermore, the memory 1212 may store additional modules and data structures not described above.

### <Aspects of the Present Disclosure>

Hereinafter, some aspects of the present disclosure will be additionally stated.

### Example 1

According to an aspect of the present disclosure, there is provided a method for tracking a piece of music in an audio stream, including: receiving a first portion of the audio stream; extracting a first sound feature based on the first portion of the audio stream; determining whether the first portion of the audio stream is indicative of music based on the first sound feature; identifying a first piece of music based on the first portion of the audio stream, in response to determining that the first portion of the audio stream is indicative of music; receiving a second portion of the audio stream; extracting a second sound feature based on the second portion of the audio stream; and determining whether the second portion of the audio stream is indicative of the first piece of music.

### Example 2

In the method of Example 1, receiving the first portion of the audio stream includes receiving a plurality of portions of the audio stream periodically in accordance with a duty cycle of a sound sensor.

### Example 3

The method of Example 1 or 2 further includes generating a music model indicative of the first piece of music based on at least one sound feature extracted from the first portion of the audio stream.

### Example 4

In the method of any one of Examples 1 to 3, generating the music model indicative of the first piece of music includes: sending a request, to an external device, for the music model indicative of the first piece of music, wherein the request includes the at least one sound feature extracted from the first portion of the audio stream; and receiving the music model from the external device.

### Example 5

In the method of any one of Examples 1 to 4, generating the music model includes modifying a predetermined music model based on the at least one sound feature extracted from the first portion of the audio stream.

### Example 6

In the method of any one of Examples 1 to 5, determining whether the second portion of the audio stream is indicative of the first piece of music is based on the music model and at least one sound feature extracted from the second portion of the audio stream.

### Example 7

The method of any one of Examples 1 to 6 further includes: receiving a third portion of the audio stream in response to determining that the second portion is not indicative of the first piece of music; extracting a third sound feature based on the third portion of the audio stream; determining whether the third portion of the audio stream is indicative of music based on the third sound feature; and identifying a second piece of music based on the third portion of the audio stream, in response to determining that the third portion of the audio stream is indicative of music.

### Example 8

In the method of any one of Examples 1 to 7, identifying the second piece of music based on the third portion of the audio stream includes: sending a request, to an external device, wherein the request includes at least one sound feature extracted from the third portion of the audio stream; receiving information, from the external device, associated with the second piece of music; and identifying the second piece of music based on the received information from the external device.

### Example 9

In the method of any one of Examples 1 to 8, identifying the first piece of music includes obtaining identification information from an external device such as a server.

### Example 10

The method of any one of Examples 1 to 9 further includes receiving a third portion of the audio stream in response to determining that the second portion of the audio stream is indicative of the first piece of music. In this example, receiving the third portion of the audio stream includes receiving a plurality of portions of the audio stream periodically in accordance with the duty cycle of the sound sensor.

### Example 11

According to another aspect of the present disclosure, there is provided an electronic device for tracking a piece of music in an audio stream, including: a music detection unit configured to receive a first portion of the audio stream; extract a first sound feature based on the first portion of the audio stream; and determine whether the first portion of the audio stream is indicative of music based on the first sound feature; a music identification unit configured to identify a first piece of music based on the first portion of the audio stream, in response to determining that the first portion is indicative of music; and a music tracking unit configured to receive a second portion of the audio stream; extract a second sound feature based on the second portion of the audio stream; and determine whether the second portion of the audio stream is indicative of the first piece of music.

### Example 12

In the electronic device of Example 11, the music detection unit is configured to receive a plurality of portions of the audio stream periodically in accordance with a duty cycle of a sound sensor.

### Example 13

The electronic device of Example 11 or 12 further includes a music model management unit configured to generate a music model indicative of the first piece of music based on at least one sound feature extracted from the first portion of the audio stream.

### Example 14

In the electronic device of any one of Examples 11 to 13, the music model management unit is configured to send a request, to an external device, for the music model indicative of the first piece of music, wherein the request includes the at least one sound feature extracted from the first portion of the audio stream; and receive the music model from the external device.

### Example 15

In the electronic device of any one of Examples 11 to 14, the music model management unit is configured to modify a predetermined music model based on the at least one sound feature extracted from the first portion of the audio stream.

### Example 16

In the electronic device of any one of Examples 11 to 15, the music detection unit, in response to determining that the second portion of the audio stream is not indicative of the piece of music, is configured to receive a third portion of the audio stream; extract a third sound feature based on the third portion of the audio stream; and determine whether the third portion of the audio stream is indicative of music based on the third sound feature. In this example, the music identification unit, in response to determining that the third portion of the audio stream is indicative of music, is configured to identify a second piece of music based on the third portion of the audio stream.

### Example 17

In the electronic device of any one of Examples 11 to 16, the music identification unit configured to identify the second piece of music is configured to send a request, to an external device, wherein the request includes at least one sound feature extracted from the third portion of the audio stream; receive information, from the external device, associated with the second piece of music; and identify the second piece of music based on the received information from the external device.

### Example 18

In the electronic device of any one of Examples 11 to 17, the music identification unit is configured to obtain identification information from an external device.

### Example 19

According to still another aspect of the present disclosure, there is provided an electronic device for tracking a piece of music in an audio stream, including: means for receiving a first portion of the audio stream; means for extracting a first sound feature based on the first portion of the audio stream; means for determining whether the first portion of the audio stream is indicative of music based on the first sound feature; means for identifying a first piece of music based on the first portion of the audio stream, in response to determining that the first portion of the audio stream is indicative of music; means for receiving a second portion of the audio stream; means for extracting a second sound feature based on the second portion of the audio stream; and means for determining whether the second portion of the audio stream is indicative of the first piece of music.

### Example 20

In the electronic device of Example 19, the means for receiving the first portion of the audio stream includes means for receiving a plurality of portions of the audio stream periodically in accordance with a duty cycle of a sound sensor.

### Example 21

The electronic device of Example 19 or 20 further includes means for generating a music model indicative of the first piece of music based on at least one sound feature extracted from the first portion of the audio stream.

### Example 22

In the electronic device of any one of Examples 19 to 21, the means for generating the music model indicative of the first piece of music includes: means for sending a request, to an external device, for the music model indicative of the first piece of music. In this example, the request includes the at least one sound feature extracted from the first portion of the audio stream; and means for receiving the music model from the external device.

### Example 23

In the electronic device of any one of Examples 19 to 22, the means for generating the music model includes means for modifying a predetermined music model based on the at least one sound feature extracted from the first portion of the audio stream.

### Example 24

In the electronic device of any one of Examples 19 to 23, the means for determining whether the second portion of the audio stream is indicative of the first piece of music is based on the music model and at least one sound feature extracted from the second portion of the audio stream.

### Example 25

The electronic device of any one of Examples 19 to 24 further includes: means for receiving a third portion of the audio stream in response to determining that the second portion is not indicative of the first piece of music; means for extracting a third sound feature based on the third portion of the audio stream; means for determining whether the third portion of the audio stream is indicative of music based on the third sound feature; and means for identifying a second piece of music based on the third portion of the audio stream, in response to determining that the third portion of the audio stream is indicative of music.

### Example 26

In the electronic device of any one of Examples 19 to 25, the means for identifying the second piece of music based on the third portion of the audio stream includes: means for sending a request, to an external device, wherein the request includes at least one sound feature extracted from the third portion of the audio stream; means for receiving information, from the external device, associated with the second piece of music; and means for identifying the second piece of music based on the received information from the external device.

### Example 27

In the electronic device of any one of Examples 19 to 26, the means for identifying the piece of music is configured to obtain identification information from an external device such as a server.

### Example 28

According to yet another aspect of the present disclosure, there is provided a non-transitory computer-readable storage medium including instructions causing a processor of an electronic device to perform operations of: receiving a first portion of an audio stream; extracting a first sound feature based on the first portion of the audio stream; determining whether the first portion of the audio stream is indicative of music based on the first sound feature; identifying a first piece of music based on the first portion of the audio stream, in response to determining that the first portion of the audio stream is indicative of music; receiving a second portion of the audio stream; extracting a second sound feature based on the second portion of the audio stream; and determining whether the second portion of the audio stream is indicative of the first piece of music.

### Example 29

In the non-transitory computer-readable storage medium of Example 28, receiving the first portion of the audio stream includes receiving a plurality of portions of the audio stream periodically in accordance with a duty cycle of a sound sensor.

### Example 30

The non-transitory computer-readable storage medium of Example 28 or 29 further includes instructions causing the processor of the electronic device to perform operations of receiving a third portion of the audio stream in response to determining that the second portion is not indicative of the first piece of music; extracting a third sound feature based on the third portion of the audio stream; determining whether the third portion of the audio stream is indicative of music based on the third sound feature; and identifying a second piece of music based on the third portion of the audio stream, in response to determining that the third portion of the audio stream is indicative of music.

What is claimed:

1. A method, performed in an electronic device, for tracking a piece of music in an audio stream, comprising:
receiving a first portion of the audio stream from a sound sensor;
extracting a first sound feature based on the first portion of the audio stream;
determining whether the first portion of the audio stream is indicative of music based on the first sound feature;
identifying a first piece of music based on the first portion of the audio stream, in response to determining that the first portion of the audio stream is indicative of music;
receiving a second portion of the audio stream;
extracting a second sound feature based on the second portion of the audio stream; and
determining whether the second portion of the audio stream is indicative of the first piece of music.

2. The method of claim 1, wherein receiving the first portion of the audio stream comprises receiving a plurality of portions of the audio stream periodically in accordance with a duty cycle of a sound sensor.

3. The method of claim 2, further comprising generating a music model indicative of the first piece of music based on at least one sound feature extracted from the first portion of the audio stream.

4. The method of claim 3, wherein generating the music model indicative of the first piece of music comprises:
sending a request, to an external device, for the music model indicative of the first piece of music, wherein the request includes the at least one sound feature extracted from the first portion of the audio stream; and
receiving the music model from the external device.

5. The method of claim 3, wherein generating the music model comprises modifying a predetermined music model based on the at least one sound feature extracted from the first portion of the audio stream.

6. The method of claim 3, wherein determining whether the second portion of the audio stream is indicative of the first piece of music is based on the music model and at least one sound feature extracted from the second portion of the audio stream.

7. The method of claim 2, further comprising:
receiving a third portion of the audio stream in response to determining that the second portion is not indicative of the first piece of music;
extracting a third sound feature based on the third portion of the audio stream;
determining whether the third portion of the audio stream is indicative of music based on the third sound feature; and
identifying a second piece of music based on the third portion of the audio stream, in response to determining that the third portion of the audio stream is indicative of music.

8. The method of claim 7, wherein identifying the second piece of music based on the third portion of the audio stream comprises:
sending a request, to an external device, wherein the request includes at least one sound feature extracted from the third portion of the audio stream;
receiving information, from the external device, associated with the second piece of music; and
identifying the second piece of music based on the received information from the external device.

9. The method of claim 1, wherein identifying the first piece of music comprises obtaining identification information from an external device.

10. The method of claim 2, further comprising receiving a third portion of the audio stream in response to determining that the second portion of the audio stream is indicative of the first piece of music, wherein receiving the third portion of the audio stream comprises receiving a plurality of portions of the audio stream periodically in accordance with the duty cycle of the sound sensor.

11. An electronic device for tracking a piece of music in an audio stream, comprising:
a music detection unit configured to:
receive a first portion of the audio stream;
extract a first sound feature based on the first portion of the audio stream; and
determine whether the first portion of the audio stream is indicative of music based on the first sound feature;
a music identification unit configured to identify a first piece of music based on the first portion of the audio stream, in response to determining that the first portion is indicative of music; and
a music tracking unit configured to:
receive a second portion of the audio stream;
extract a second sound feature based on the second portion of the audio stream; and
determine whether the second portion of the audio stream is indicative of the first piece of music.

12. The electronic device of claim 11, wherein the music detection unit is configured to receive a plurality of portions of the audio stream periodically in accordance with a duty cycle of a sound sensor.

13. The electronic device of claim 12, further comprising a music model management unit configured to generate a music model indicative of the first piece of music based on at least one sound feature extracted from the first portion of the audio stream.

14. The electronic device of claim 13, wherein the music model management unit is configured to:
send a request, to an external device, for the music model indicative of the first piece of music, wherein the request includes the at least one sound feature extracted from the first portion of the audio stream; and
receive the music model from the external device.

15. The electronic device of claim 13, wherein the music model management unit is configured to modify a predetermined music model based on the at least one sound feature extracted from the first portion of the audio stream.

16. The electronic device of claim 12, wherein the music detection unit, in response to determining that the second portion of the audio stream is not indicative of the piece of music, is configured to:
receive a third portion of the audio stream;
extract a third sound feature based on the third portion of the audio stream; and
determine whether the third portion of the audio stream is indicative of music based on the third sound feature, and
wherein the music identification unit, in response to determining that the third portion of the audio stream is indicative of music, is configured to identify a second piece of music based on the third portion of the audio stream.

17. The electronic device of claim 16, wherein the music identification unit configured to identify the second piece of music is configured to:
send a request, to an external device, wherein the request includes at least one sound feature extracted from the third portion of the audio stream;
receive information, from the external device, associated with the second piece of music; and
identify the second piece of music based on the received information from the external device.

18. The electronic device of claim 11, wherein the music identification unit is configured to obtain identification information from an external device.

19. An electronic device for tracking a piece of music in an audio stream, comprising:
means for receiving a first portion of the audio stream;
means for extracting a first sound feature based on the first portion of the audio stream;
means for determining whether the first portion of the audio stream is indicative of music based on the first sound feature;
means for identifying a first piece of music based on the first portion of the audio stream, in response to determining that the first portion of the audio stream is indicative of music;
means for receiving a second portion of the audio stream;
means for extracting a second sound feature based on the second portion of the audio stream; and
means for determining whether the second portion of the audio stream is indicative of the first piece of music.

20. The electronic device of claim 19, wherein the means for receiving the first portion of the audio stream comprises means for receiving a plurality of portions of the audio stream periodically in accordance with a duty cycle of a sound sensor.

21. The electronic device of claim 20, further comprising means for generating a music model indicative of the first piece of music based on at least one sound feature extracted from the first portion of the audio stream.

22. The electronic device of claim 21, wherein the means for generating the music model indicative of the first piece of music comprises:
means for sending a request, to an external device, for the music model indicative of the first piece of music, wherein the request includes the at least one sound feature extracted from the first portion of the audio stream; and
means for receiving the music model from the external device.

23. The electronic device of claim 21, wherein the means for generating the music model comprises means for modifying a predetermined music model based on the at least one sound feature extracted from the first portion of the audio stream.

24. The electronic device of claim 21, wherein the means for determining whether the second portion of the audio stream is indicative of the first piece of music is based on the music model and at least one sound feature extracted from the second portion of the audio stream.

25. The electronic device of claim 20, further comprising:
means for receiving a third portion of the audio stream in response to determining that the second portion is not indicative of the first piece of music;
means for extracting a third sound feature based on the third portion of the audio stream;
means for determining whether the third portion of the audio stream is indicative of music based on the third sound feature; and
means for identifying a second piece of music based on the third portion of the audio stream, in response to determining that the third portion of the audio stream is indicative of music.

26. The electronic device of claim 25, wherein the means for identifying the second piece of music based on the third portion of the audio stream comprises:
means for sending a request, to an external device, wherein the request includes at least one sound feature extracted from the third portion of the audio stream;
means for receiving information, from the external device, associated with the second piece of music; and
means for identifying the second piece of music based on the received information from the external device.

27. The electronic device of claim 19, wherein the means for identifying the piece of music is configured to obtain identification information from an external device.

28. A non-transitory computer-readable storage medium comprising instructions causing at least a processor of an electronic device to perform operations of:
receiving a first portion of an audio stream;
extracting a first sound feature based on the first portion of the audio stream;
determining whether the first portion of the audio stream is indicative of music based on the first sound feature;
identifying a first piece of music based on the first portion of the audio stream, in response to determining that the first portion of the audio stream is indicative of music;
receiving a second portion of the audio stream;
extracting a second sound feature based on the second portion of the audio stream; and
determining whether the second portion of the audio stream is indicative of the first piece of music.

29. The non-transitory computer-readable storage medium of claim 28, wherein receiving the first portion of the audio stream comprises receiving a plurality of portions of the audio stream periodically in accordance with a duty cycle of a sound sensor.

30. The non-transitory computer-readable storage medium of claim 28, further comprising instructions causing the at least a processor of the electronic device to perform operations of:
receiving a third portion of the audio stream in response to determining that the second portion is not indicative of the first piece of music;
extracting a third sound feature based on the third portion of the audio stream;
determining whether the third portion of the audio stream is indicative of music based on the third sound feature; and
identifying a second piece of music based on the third portion of the audio stream, in response to determining that the third portion of the audio stream is indicative of music.
